(19) United States
(12) Patent Application Publication
(10) Pub. No.: US 2022/0392313 A1
(43) Pub. Date: Dec. 8, 2022

(54) GAMBLING GAME, GAME PLATFORM FOR SUCH A GAME AND METHOD OF PLAYING THE GAME

(71) Applicant: Armin MIRALRIO, Cuernavaca (MX)

(72) Inventor: Armin MIRALRIO, Cuernavaca (MX)

(21) Appl. No.: 17/335,615

(22) Filed: Jun. 1, 2021

(51) Int. Cl. G07F 17/32

(52) U.S. Cl. CPC G07F 17/3288; G07F 17/3204

(57) ABSTRACT

A game platform for a gambling game, comprises: a main triangle with three edges; a plurality of equally sized second order triangles arranged non-overlapping within the bounds of the main triangle; and a plurality of sub-triangles arranged within each second order triangle, the sub-triangles within each second order triangle partly overlapping each other, so that edges of pairs of sub-triangles are coinciding with each other. Additional sub-triangles are formed in border areas where the edges of the second-order triangles meet. Further, an additional sub-triangle is formed by the main triangle. Play areas are arranged at each edge area of each sub-triangle, wherein each play area is arranged at, or in the vicinity of, an edge in two different sub-triangles.

### FIELD OF THE INVENTION

The present invention relates to a gambling game, and a platform for playing such a gambling game.

### BACKGROUND OF THE INVENTION

There is a strong demand for gambling games, and nowadays, games such as casino, poker, etc. can be played both as physical games, in amusement halls, casinos, gaming clubs, and similar locations, and as on-line games, plaid on computers, smartphones, tablets and the like. However, even though the classic games, such as casino and poker, are still very popular, there is still a need for new and alternative gambling games.

### SUMMARY OF THE INVENTION

It is therefore an object of the present invention to provide new gambling game, and in particular a game platform for such a gambling game, and a method for playing a gambling game.

This object is achieved with a game platform and a method according to the appended claims.

According to one aspect of the invention there is provided a game platform for a gambling game, comprising: a main triangle with three edges; a plurality of equally sized second order triangles arranged, arranged non-overlapping within the bounds of the main triangle; a plurality of sub-triangles arranged within each second order triangle, the sub-triangles within each second order triangle partly overlapping each other, so that edges of pairs of sub-triangles are coinciding with each other; additional sub-triangles formed in border areas where the edges of the second-order triangles meet; an additional sub-triangle formed by the main triangle; and play areas arranged at each edge area of each sub-triangle, wherein each play area is arranged at, or in the vicinity of, an edge in two different sub-triangles.

In one embodiment, the four second order triangles are provided within the main triangle, three of which are arranged at each edge of the main triangle, and one being arranged in the center.

Further, in one embodiment the four second order triangles are essentially filling the area of the main triangle, and wherein the three triangles at the edges are directed in the same way as the main triangle, whereas the fourth triangle arranged in the center is oppositely directed.

In one embodiment, three sub-triangles are provided in each of the second order triangles.

In one embodiment, a totality of 16 sub-triangles and 24 playing areas are provided in the platform.

In one embodiment, each playing area is semi-randomly assigned a sequential number, referred to as “Sit_Number”. The Sit_Numbers are arranged based on calculations in order to ensure that every number 1 to 8 get placed in 3 different edges where it competes not with itself but with the other 7 numbers at least 1 time.

In one embodiment, each second order triangle comprises six play areas.

Further, in one embodiment, the play areas in each second order triangle comprises play areas in three different colors, forming three pairs of equally colored play areas, wherein one of the play areas of each such pair is arranged at an edge of the second order triangle, and the other play area of the pair is arranged oppositely to this edge, at the middle of the opposite vertex.

Still further, in one embodiment, each sub-triangle comprises three play areas of different colors, whereby play areas of all the three colors are present in each sub-triangle.

Still further, in one embodiment, the play areas are sequentially numbered, wherein the number series is repeated for each color of the play areas.

According to another aspect of the invention, there is provided a method for playing a gambling game, comprising: providing a game platform in accordance with the discussion above; providing a set of distinct elements, wherein each combination of any two of these element result in a characteristic feature being either present or non-present in such a combination: assigning the elements to the play areas of the game platform; determine which possible combinations of elements within at least some of the sub-triangles that contain the characteristic feature and which do not; determine elements that wins, loses or are equal in each sub-triangle based on the characteristic features of these combinations.

In one embodiment, the elements comprise distinct geometrical shapes, which, when combined, either form distinctive closed structures or not.

Further, in one embodiment, the distinctive closed structures are squares or triangles.

Further, in one embodiment, eight different, distinct elements are provided.

In one embodiment, more than 50% of all possible combinations of the elements result in the characteristic feature being present, and wherein combination with the characteristic feature being present wins over combinations where the characteristic feature is not present.

Further, in one embodiment, 55-60% of all possible combinations of the elements result in the characteristic feature being present.

These and other aspects of the invention will be apparent from and elucidated with reference to the embodiments described hereinafter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For exemplifying purposes, the invention will be described in closer detail in the following with reference to embodiments thereof illustrated in the attached drawings, wherein:

FIGS. 1a-1o are schematic overview of so-called elements and shapes in accordance with embodiments of the present invention;

FIGS. 2a-f are illustrations of an exemplary game platform, in accordance with an embodiment, where FIGS. 2a-b illustrate the 3D and 2D representations of the game platform, FIG. 2c illustrates the exemplary game platform, FIGS. 2d and 2e schematically illustrate various components of the game platform, and FIG. 2f is a schematic illustration of the common edges for all combinations of the sub-triangles in the exemplary game platform of FIG. 2c;

FIG. 3 is a schematic illustration of how elements are assigned to the edges of the sub-triangles in accordance with a sit-order;

FIGS. 4a-f are schematic illustrations of examples of the resulting win-lose and equal situation in various sub-triangles of the game platform;

FIG. 5 illustrates all the possible combinations between three elements in any sub-triangle inside the game platform, and the result of these combinations;

FIG. 6 is a further schematic illustration of a resulting outcome;

FIG. 7 is a more detailed illustration of the resulting outcome for the game platform for all the edges of FIG. 3;

FIG. 8 is an illustration of a game table layout in accordance with an embodiment;

FIG. 9 is an illustration of the game table layout as used during a game;

FIG. 10 is an illustration of a tournament result presentation layout; and

FIG. 11a is an exemplary illustration of the game platform during playing of the luck class 1 version of the game, and FIG. 11b is an illustration of a combined game platform and game table;

FIGS. 12a-e are illustrations of playing the skill class 1 (S1) of the game, wherein FIG. 12a is a table for Sit-Numbers for each level, FIG. 12b is a table illustrating how every Sit_Number competes against other Sit_Orders, FIG. 12c illustrates how each player obtains his Sit_Hand in a round, FIG. 12d shows the game platform after generation of the Random_Order, and FIG. 12e illustrates how a player who has obtained a Sit_Order can choose his desired element at each level;

FIGS. 13a-e are illustrations of playing the skill class 2 (S2) of the game, wherein FIG. 13a illustrates how each second order triangle is recognized by a predefined sign, FIG. 13b shows generation of the players Sit_Hands, FIG. 13c shows a table showing the Sit_Numbers for each level, FIG. 13d shows an example of a game platform when the game has started by generation of a Random_Order, and FIG. 13e illustrate how a player how a player who has chosen the Triangle M can choose his desired element at each level;

FIG. 14 illustrates how the results may be presented, both for a Face version, to the left, and the Triangle version, to the right, for Luck Class 1 (L1);

FIG. 15 illustrates how the results may be presented, both for a Face version, to the left, and the Triangle version, to the right, for Luck Class 2 (L2);

FIGS. 16a1, 16a2, 16b1 and 16b2 are illustrations of the game played in Skill Class 1 (S1), where FIGS. 16a1 and b1 show the Sit_Hands at the moment after the Random_Order has been generated and before the first player starts to play, whereas FIGS. 16a2 and b2 show a presumed final standing after having completed a third level, wherein FIGS. 16a1 and a2 illustrate a face version of the game, whereas FIGS. 16b1 and b2 illustrate a triangle version of the game; and

FIGS. 17a1, 17a2, 17b1 and 17b2 are illustrations of the game played in Skill Class 2 (S2), where FIGS. 17a1 and b1 show the Sit_Hands at the moment after the Random_Order has been generated and before the first player starts to play, whereas FIGS. 17a2 and b2 show a presumed final standing after having completed a sixth level, wherein FIGS. 17a1 and a2 illustrate a face version of the game, whereas FIGS. 17b1 and b2 illustrate a triangle version of the game.

### DESCRIPTION OF PREFERRED EMBODIMENTS

In the following detailed description, preferred embodiments of the present invention will be described. However, it is to be understood that features of the different embodiments are exchangeable between the embodiments and may be combined in different ways, unless anything else is specifically indicated. It may also be noted that, for the sake of clarity, the dimensions of certain components illustrated in the drawings may differ from the corresponding dimensions in real-life implementations of the invention, for instance.

Generally about the Game

The invention is related to a new gambling game. The game can be realized by software, and e.g. be provided for play as an on-line game, for example provided on a web based platform, accessible e.g. by general purpose computers, or by dedicated computers provided e.g. in amusement halls, casinos, gambling clubs, etc. For use in such public places, and also for other purposes, the game can alternatively be provided only locally, e.g. in a local network at the facility, or even on a single, stand-alone device. The game can also be realized as an application, e.g. for use on smartphones, tablets and the like.

Alternatively, the game can be realized fully or partly in hardware, e.g. by providing a physical game table, using physical chips or markers for placing bets on the game table, etc.

The new gambling game can be plaid in different ways, as will be discussed in more detail in the following, e.g. based purely on luck, or in various ways also involving skills and strategies of the players.

The new gambling game offers a very low risk gambling, with chances to win e.g. a jackpot or double the bet. The outcome may also be a draw, in which case the bet is returned to the player. Alternatively, the player may, if less successful, may lose either the whole or half the bet. The amount lost cannot exceed the initial bet, while the winning amount can be at least two times the amount of the bet, and up to the jackpot, which could be any possible amount. The game also allows player to use multiple bets, to maximize the chances of winning.

The game can generally be played in two versions—the face version and the triangular version.

In respect of the face version, the term “Face” here refers in fact to the 2 diagonals of the square, namely X and Y. In other words, the game in this version is just based on these 2 diagonals in accordance with the four triangles inside the square.

Hence, by assuming 3 Elements that are assigned among the 3 edges on a sub-triangle, the Element with the different diagonal than the 2 other Elements Wins and the other 2 Elements Lose inside that sub-triangle. Hereby, if all these 3 Elements have the same diagonal, then they get Equal inside that sub-triangle.

Thus, here each Element that is sitting on an edge of a sub-triangle, “competes” against the 2 other Elements that are sitting on the 2 other edges of that same sub-triangle. In addition, due to the fact that every Sit_Number is sitting in the common edge of 2 sub-triangles, therefore the Element assigned to that Sit_Number is getting one result in each of those 2 sub-triangles. As a matter of fact, all the Elements which get arranged among the Sit_Numbers throughout the Game-Platform, reach 2 results after the Competition based on the special design of the Game-Platform where every Element is sitting in the common edge of 2 sub-triangles, but with one final condition at the end of the game.

In the triangle version, and as mentioned above, after assigning each Element to a Sit_Order, every Element is indeed sitting in the common edge of 2 sub-triangles. In other words, every Element gets placed in 2 edges of 2 separate sub-triangles where it competes against the other 2 Elements in each of those 2 sub-triangles. As mentioned above, the term competition in the Face Version was just about the 2 diagonals of the square toward the Elements. On the other side, the term competition in the Triangle Version is in fact indicating on the Combination of every Element within each of the other 2 Elements on the same sub-triangle.

The result of the Combination of every 2 Elements is a new figure called a Shape. In other words, the Combination of 2 Elements can be simply defined by putting those 2 Elements together inside the primitive square. By combining every Element with the other 7 Elements, with respect to non-regular order (AB=BA), there will be created 28 Shapes.

Hereby, in any sub-triangle the only Element that creates a Shape which includes either 1 or 2 of the triangles inside the primitive square (U-R-M-L) in Combination with each of the 2 other Elements, Wins in that sub-triangle where in result, the other 2 Elements Lose in that specific sub-triangle. Moreover, if the 3 Elements that are sitting on the edges of a sub-triangle create those Shapes which do not contain any of the triangles (such as AB, CH, DG, etc), then these 3 Elements are Equal inside that particular sub-triangle.

Fundamentally, it might be reasonable to say that the game through both of the Versions is actually based on the same concept due to the fact that for an Element to create 2 Shapes including triangles within the 2 other Elements in a sub-triangle (necessity to Win in TV), it requires to have a different diagonal than the other 2 Elements in that same sub-triangle (necessity to Win in FV).

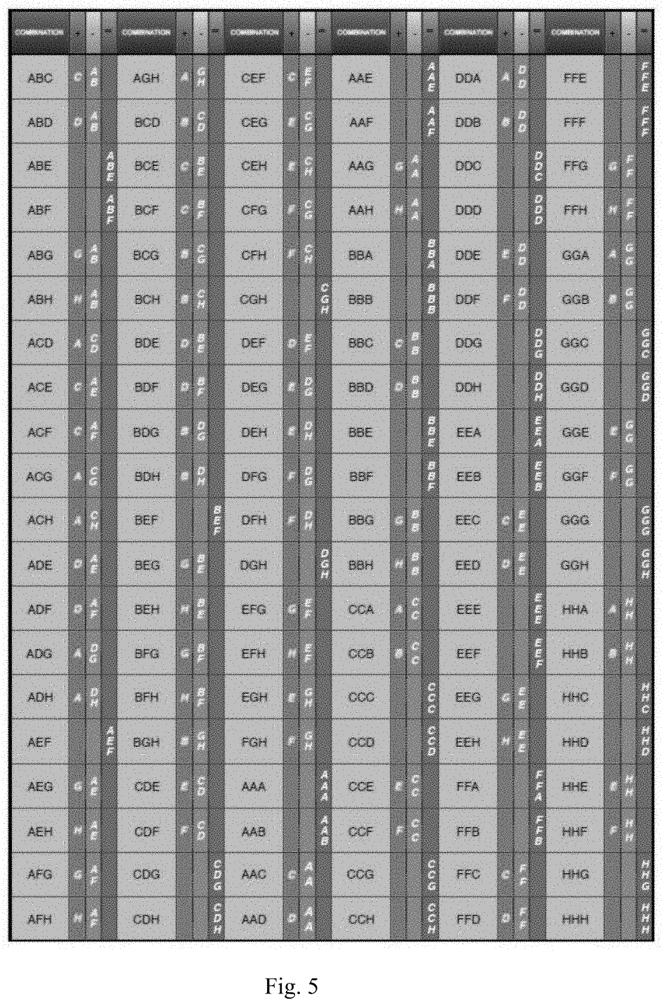

The total number of possible Combinations between any 3 Elements in a sub-triangle, with respect to non-regular order (ABC=ACB=BCA=BAC=CAB=CBA), is 120 that includes the probability of 2 or 3 same Elements in a sub-triangle as well. The table in FIG. 5 shows all the possible Combinations through TV as well as Competitions through FV between 3 Elements in any sub-triangle inside the Game-Platform with respect to non-regular order. In addition, it is also clarified that for each Combination (TV) and Competition (FV) which Element Wins (+) and which Elements Lose (−) or are Equal (=) among that specific sub-triangle.

### Game Elements

One basis for the game is a provision of a set of elements that may be compared to each other, to be able to determine a win, a draw or a loss from each possible combination. Preferably, eight different elements are provided.

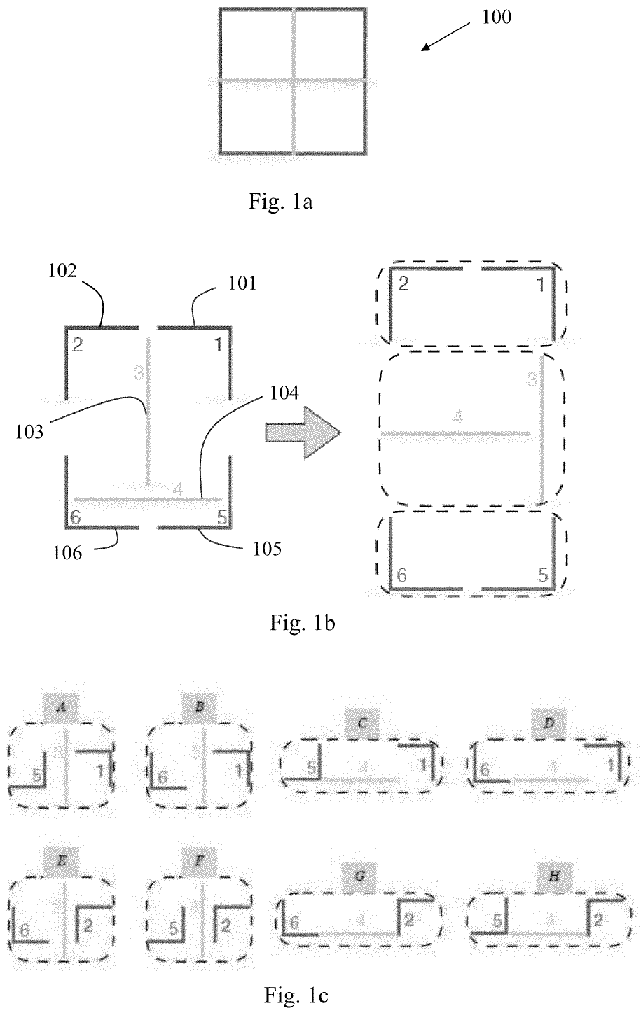

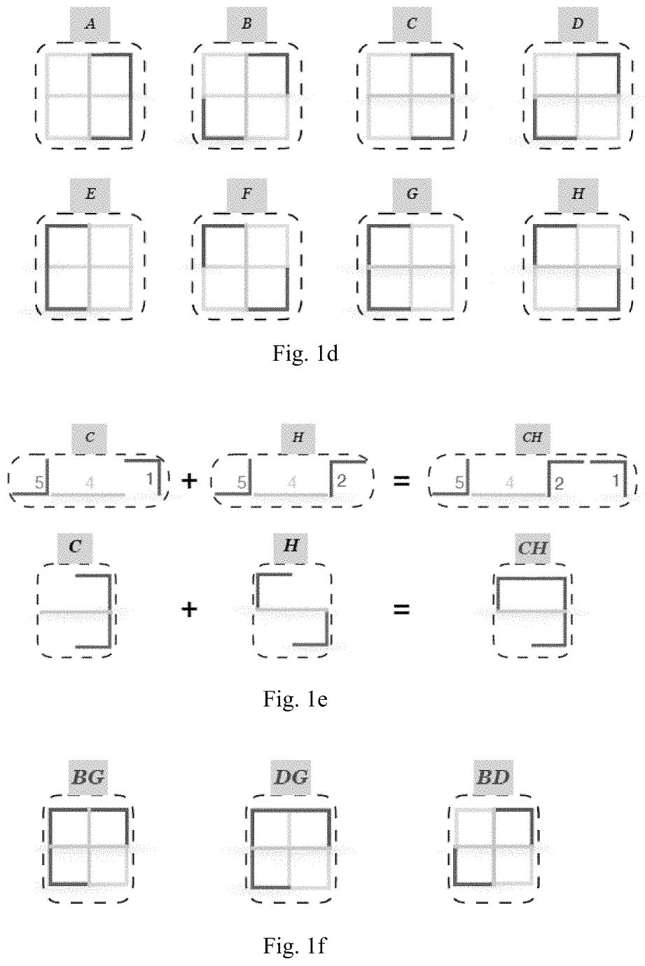

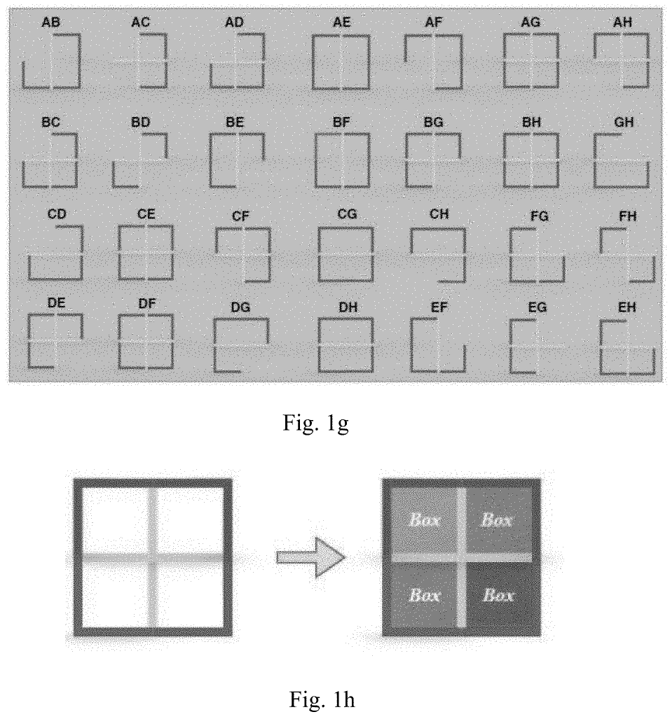

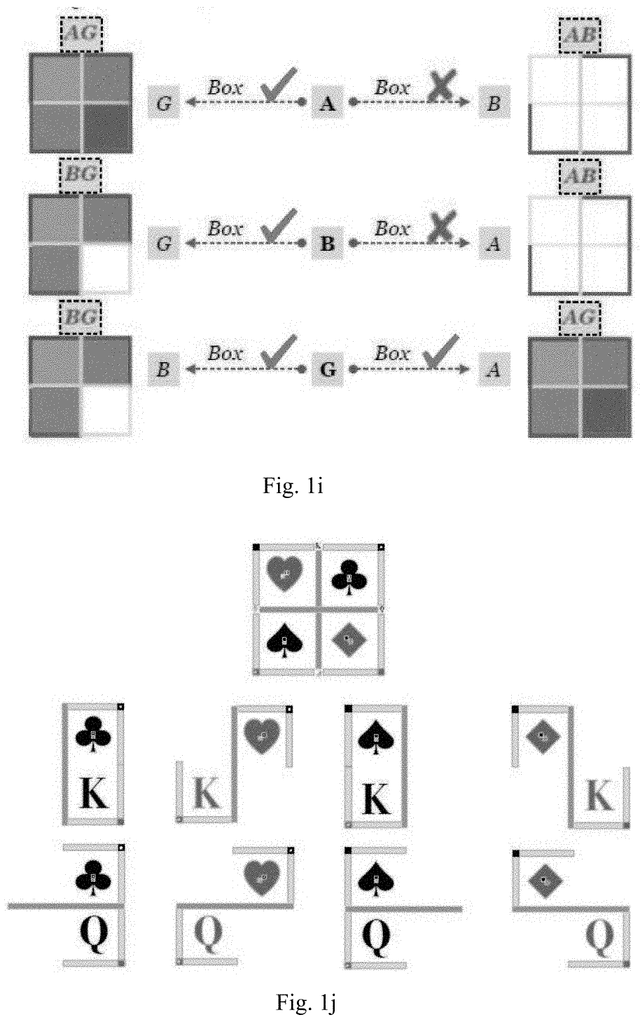

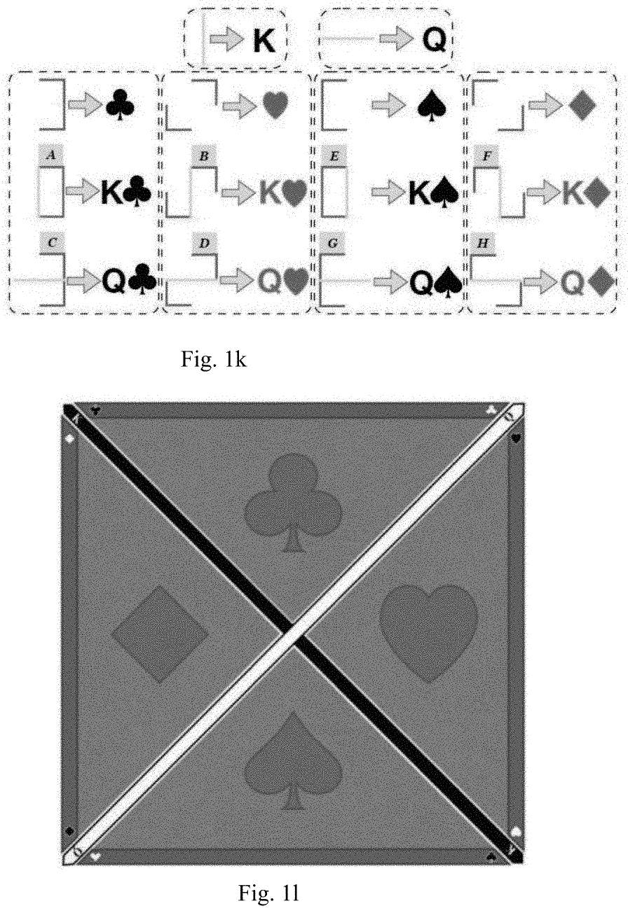

In one embodiment, the elements are formed by various combinations of lines existing in a square having four fields, as illustrated in FIGS. 1a-k. However, as will be discussed further in more detail in the following, other elements may be used as well, in the same or a similar manner, such as a square formed by four triangles.

As seen in FIG. 1a, the square 100 comprises four sides, and two interior separating lines, one extending horizontally from the right hand side to the left hand side, and one extending vertically from the upper side to the lower side. The square may be split up into six different sub-patterns, as illustrated in FIG. 1b. The sub-patterns formed by the two upper corners 101, 102, here illustrated in purple color, are considered to be within one group, the purple group, the two lower corners 105 and 106, here illustrated in green color, are considered to be within one group, the green group, and the two separating lines 103 and 104, here illustrated in yellow, are considered to be within one group, the yellow group.

The sub-patterns 101-106 are combined in sets, wherein each set comprises one sub-pattern from each of the three groups, i.e. one yellow sub-pattern, one green sub-pattern and one purple sub-pattern. As illustrated in FIG. 1c, the sub-patterns 101-106 can in this way be combined in eight various sets, denominated A-H, and forming the combinable elements. When combined, within the pattern of the original square, the elements look as illustrated in FIG. 1d.

Thus, in the illustrative example, the elements are as follows:
Element A comprises sub-patterns 101, 103 and 105, and forms a closed, standing rectangle.
Element B comprises sub-patterns 101, 103 and 106, and forms an open, S-shape.
Element C comprises sub-patterns 101, 104 and 105, and forms an open, lying T-shape.
Element D comprises sub-patterns 101, 104 and 106, and forms an open, inverted S-shape.
Element E comprises sub-patterns 102, 103 and 106, and forms a closed, standing rectangle.
Element F comprises sub-patterns 102, 103 and 105, and forms an open, inverted S-shape.
Element G comprises sub-patterns 102, 104 and 106, and forms an open, lying T-shape.
Element H comprises sub-patterns 102, 104 and 105, and forms an open, S-shape.

By combining any two of the elements A-H, new figures, in the following referred to as shapes, will be formed. The shapes are formed by placing the two elements over each other in the context of the original square.

As an example, FIG. 1e illustrates the shape CH, being the combination of element C and H, and schematically illustrates how the shapes are combined, where the upper part of FIG. 1e illustrates the set of sub-patterns belonging to element C, the set of sub-patterns belonging to element H, and the set of sub-patterns belonging to the shape CH, being the combination of elements C and H. The lower part of FIG. 1e illustrates elements C and H, and the resulting shape CH, when the sub-patterns are arranged within the context of the original square.

As further examples, FIG. 1f, in the same way, and also within the context of the original square, illustrates the shapes BG, DG and BD, respectively.

In total, the eight elements A-H can be combined into 28 different pairs, shapes, all of which are illustrated in FIG. 1g.

Going back to the original square as illustrated in FIG. 1a, it may be noted that the square, due to the vertical and horizontal separating lines 103 and 104, comprises four boxes, as illustrated in further detail in FIG. 1h.

As can be seen in FIG. 1g, some of the shapes AB-EH comprises two, three or four closed boxed, i.e. boxes which are fully encircled by the sub-patterns 101-106. Only the shapes having both the separating lines 103 and 104 contains such closed boxes. The other shapes, only comprising one of the two separating lines, do not have any closed boxes at all. In the illustrative example, this is the case for e.g. the shapes AB, AE, AF, etc.

More specifically, in the illustrative example, the shapes may be grouped as having 0, 2, 3 or 4 closed boxes:
Group with 0 closed boxes: AB, AE, AF, BE, BF, GH, CD, CG, CH, DG, DH and EF.
Group with 2 closed boxes: AC, BD, FH and EG.
Group with 3 closed boxes: AD, AH, BC, BG, CF, FG, DE and EH.
Group with 4 closed boxes: AG, BH, CE and DF.

Thus, out of the overall 28 different shapes, 12 are shapes which do not contain any boxes, 4 are shapes containing 2 closed boxes, 8 are shapes containing 3 closed boxes, and 4 are shapes containing 4 closed boxes. In other words, 16, i.e. more than half, of the shapes contain closed boxes and 12, i.e. less than half, of the shapes do not contain any closed boxes.

In the game, as will be discussed in more detail in the following, the shapes are compared with each other, to determine which out of two competing shapes that conquers over the other. The basic rules of the game are:
An element which can create a shape including a closed triangle or box in combination with each of the 2 elements sitting on the edges of a sub-triangle (see below), wins among those elements. Thus, so created a shape having two or more closed boxes triumphs over a shape without any closed boxes.
In Triangle Version (see below), the 3 elements are equal if and only if they create shapes including no closed triangle/box in combination with each other. In Face Version (see below), focus is rather on the diagonals, and if the elements have the same diagonal (e.g. elements A,B,E) then they are equal.
If both the competing shapes do not contain any closed boxes, the shapes are equal—there is a draw.

This is illustrated schematically in FIG. 1i, where we see that when comparing shapes AG and AB, shape AG, containing four closed boxes, triumphs over shape AB, containing no closed boxes. We further see that when comparing shape BG against shape AB, shape BG, containing three closed boxes, also triumphs over shape AB. When the shapes BG and AG are compared, there is a draw, and no one triumphs over the other.

The shapes and elements may be designed in different ways and may be denominated in other ways. However, it is preferred that there is provided an even number of elements, and preferably at least 4 elements, and most preferably 8 elements. The elements should further preferably be combinable into shapes in such a way that a distinctive feature, such as closed boxes, is either present or present in any such combination. The shapes are further preferably arranged in such a way that an even number of possible shapes is provided, and preferably at least 10, and more preferably at least 16, and more preferably at least 20, and more preferably at least 24, and most preferably 28. The shapes are preferably provided in such a way that at least about half of the shapes have the distinctive feature, whereas the others do not. In the illustrative examples, 28 shapes are available, of which 16 include at least one closed triangle/box, whereas 12 do not include any closed triangle/box.

An alternative embodiment is illustrated schematically in FIGS. 1j and 1k. The four boxes are here assigned with four different names or shapes. In the illustrative example, the boxes are referred to as hearts, clubs, spades and diamonds. Every element including a vertical separation line is further denominated King, K, whereas every element including a horizontal separation line is further denominated Queen, Q. Thus, the elements are hereby referred to as King and Queen of spades, King and Queen of clubs, King and Queen of hearts, and King and Queen of diamonds, or in abbreviated form: SK, SQ, CK, CQ, HK, HQ, DK and DQ. However, the King and Queen may also be referred to in other ways, such as X and Y.

In FIG. 11, the alternative of elements using triangles formed within a square are illustrated. Here, instead of having elements forming squared boxes as a distinguishing, characteristic feature when combined with other elements, the separating lines within the box are here drawn as diagonal lines instead of as vertical and horizontal lines. Here, the sides of the square may be assigned to spades, clubs, diamond and hearts, respectively, whereas the diagonal lines may be assigned to King, K, and Queen, Q, respectively.

Thus, each element will contain one vertical or horizontal line, and one diagonal line. All the 8 possible elements are illustrated in FIGS. 1m and 1n.

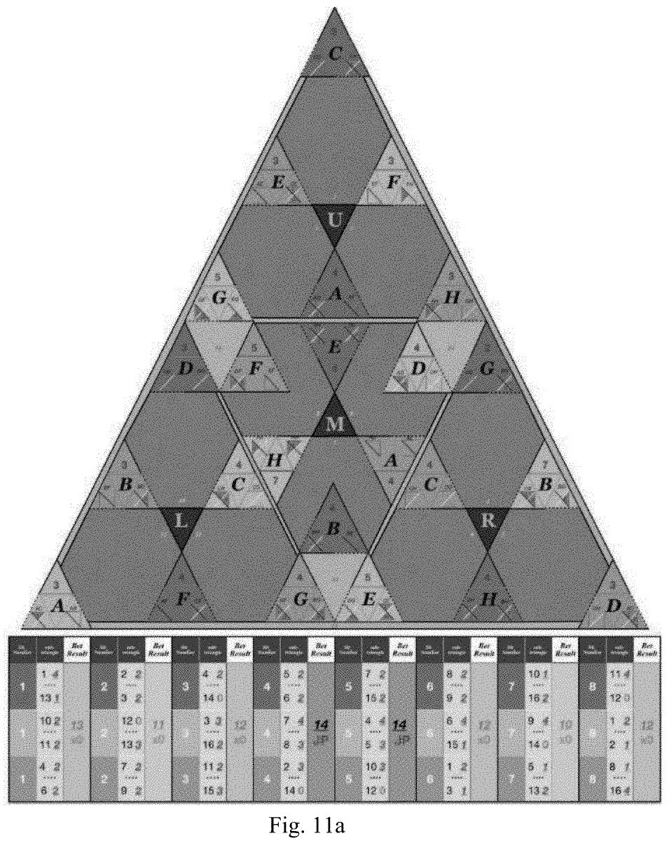

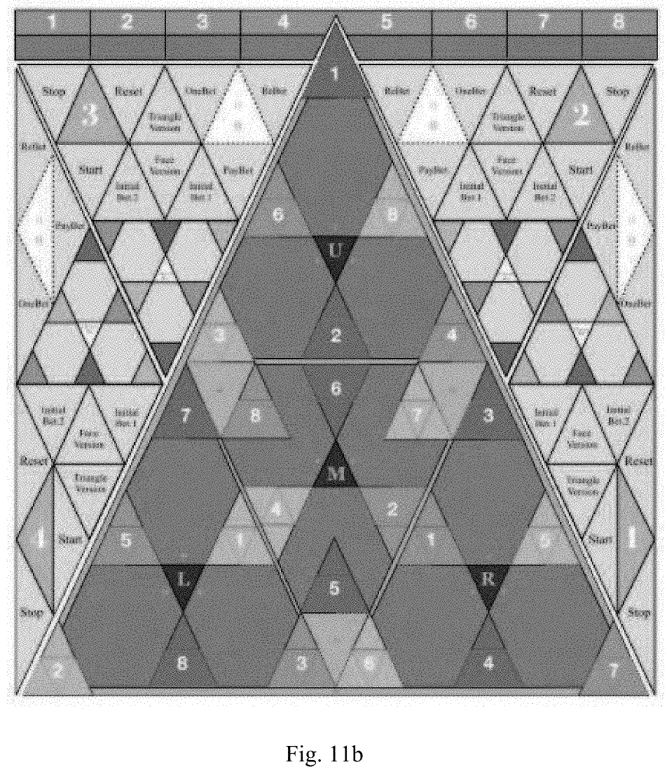

By combining the elements, the two elements will either contain a common diagonal line, in which case no closed structures will be formed, or only a large triangle, as large as half the square. Alternatively, if both the diagonal lines are present, the elements will form two closed triangles, being the size of a quarter of the square. Symbols representing all the possible combinations of the eight elements are illustrated in FIG. 10.

### Game Platform

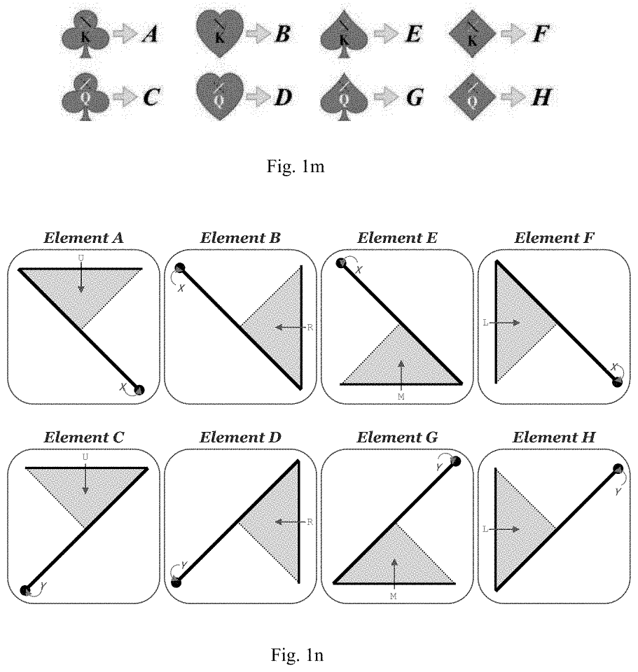

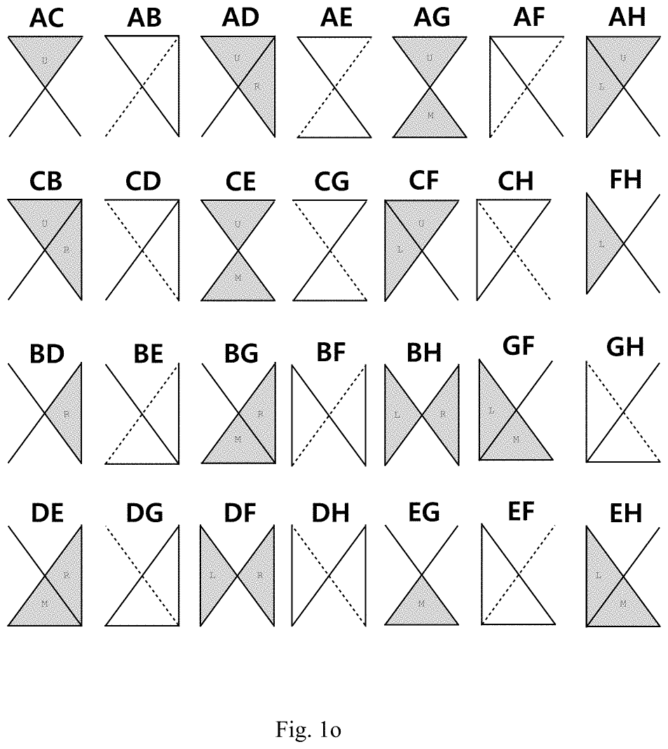

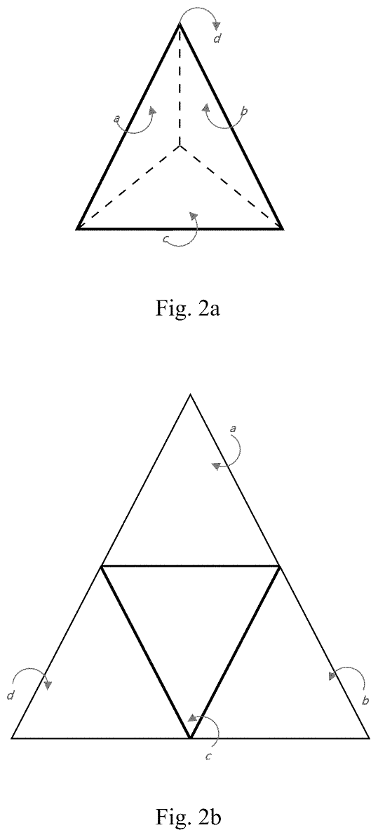

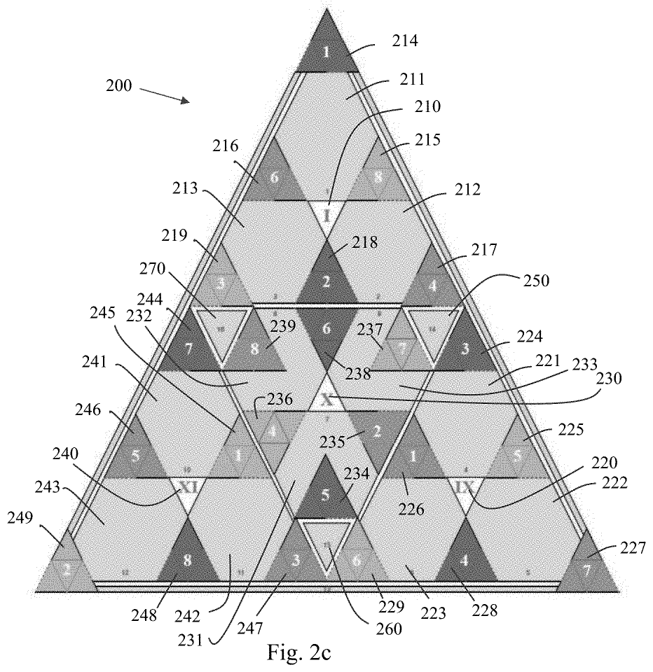

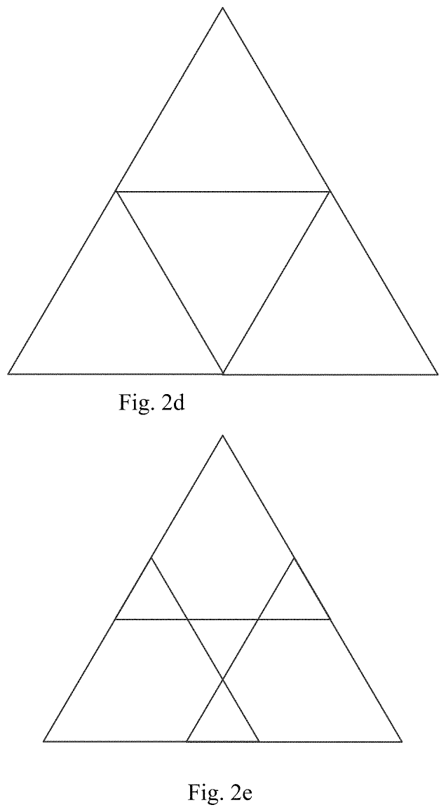

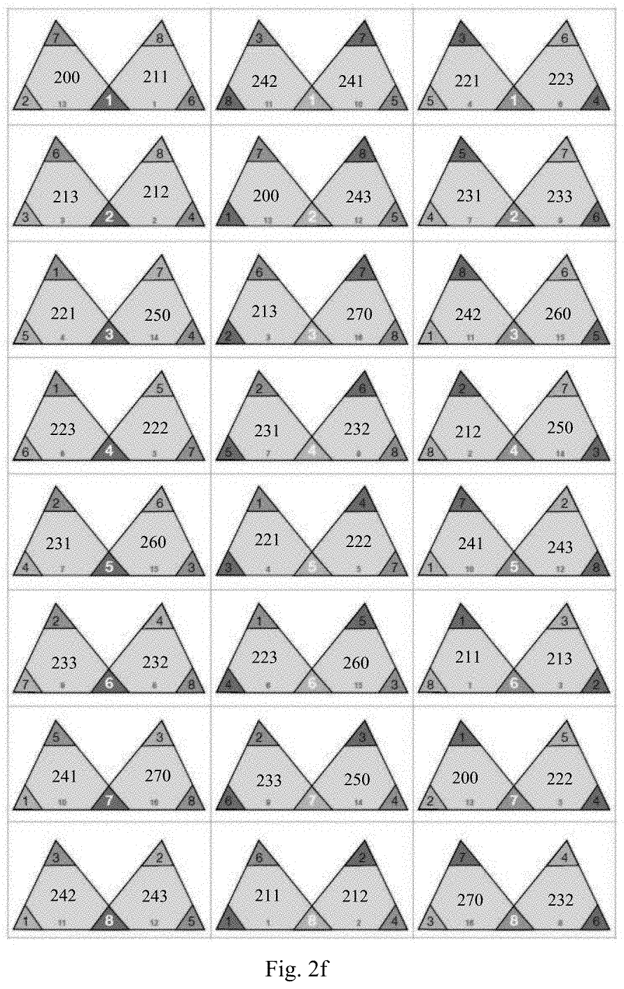

The Game platform is in fact a triangular pyramid that comprises 4 triangles where each triangle belongs to one side of the pyramid. Thus, in some embodiments, the game platform may comprise a 3D representation of the pyramid. However, for practical reasons, it is often easier to display 2D representations, and to this end, the pyramid may be represented in 2D by “folding down” the sides of the pyramid, as schematically illustrated in FIGS. 2a-b.

The game platform, in its 2D representation, comprises a main triangular shape, preferably in the shape of a regular triangle, with an upper edge and two lower edges. The main triangular shape also encloses a plurality of second order triangles. Preferably, four second order triangles are provided.

In one embodiment, illustrated in FIG. 2c, the main triangle 200 encloses four second order triangles. An upper triangle 210 is arranged with an upper edge coinciding with the upper edge of the main triangle, a right hand triangle 220 is arranged with a lower right hand edge coinciding with the right hand edge of the main triangle, and a left hand triangle 240 is arranged with a lower left hand edge coinciding with the left hand edge of the main triangle. All these triangles 210, 220 and 240 are arranged in the same direction as the main triangle, with an upper edge directed upwards, and two bottom edges directed towards the right and left. A fourth triangle 230 is arranged in between these three edges and being oppositely directed.

The four triangles 210, 220, 230 and 240 may be denominated I, X, XI and IX, and these denominations may also be visibly indicated in the center of the triangles, as in the illustrative example. However, other denominations may also be used, such as U (upper), M (middle), L (left) and R (right), or [symbol] (clubs), [symbol] (spades), ♦ (diamonds) and ♥ (hearts). In the following, the denominations U-M-L-R will be primarily used.

The vertices of all the second order triangles 210-240 are preferably all of the same length, the length preferably being half the length of the vertices of the main triangle. The edges of the centrally arranged fourth triangle 230 preferably has its edges arranged in contact with the middle of each vertex of the main triangle.

In FIG. 2d, the arrangement of the four second order triangles within the main triangle are illustrated in a more schematic way.

Returning to FIG. 2c, each of the second order triangles further comprises three sub-triangles each, which are enclosed within each of the second order triangles, and which are sized so that the edges partially overlap each other.

Thus, the second order triangle 210 comprises sub-triangle 211 at the top, and with an upper edge arranged coinciding with the upper edge of second order triangle 210, a right hand sub-triangle 212 is arranged with a lower right hand edge coinciding with the right hand edge of the second order triangle 210, and a left hand sub-triangle 213 is arranged with a lower left hand edge coinciding with the left hand edge of the second order triangle 210. All these sub-triangles 211-213 are arranged in the same direction as the second-order triangle in which they are enclosed, i.e. second order triangle 210, with an upper edge directed upwards, and two bottom edges directed towards the right and left. In the same way second order triangle 220 is provided with sub-triangles 221-223, second order triangle 230 is provided with sub-triangles 231-233, and second order triangle 240 is provided with sub-triangles 241-243.

FIG. 2e illustrate the arrangement of three sub-triangles within each of the second order triangles in a more schematic way.

Returning to FIG. 2c, each of the sub-triangles have a play area at each of the edges. Thus, each sub-triangle comprises three, separated and distributed play areas.

In this specific embodiment, the uppermost sub-triangle 211 comprises a play area 214 at the upper edge, a bottom right play area 215 at the right hand edge, and a bottom left play area 216 at the left hand edge. Correspondingly, sub-triangle 212 comprises play areas 215, 217 and 218, and sub-triangle 213 comprises play areas 216, 218 and 219. Since the sub-triangles within the second order triangle 210 partially overlap each other, the play area 215 is shared between sub-triangles 211 and 212, being at the right hand edge of sub-triangle 211 and the upper edge of sub-triangle 212. In the same way, play area 216 is shared between sub-triangles 211 and 213, and play area 218 is shared between sub-triangles 212 and 213. In total, 6 play areas are provided within the second order triangle 210.

In a corresponding manner, looking at second order triangle 220, the upper sub-triangle 221 comprises a play area 224 at the upper edge, a bottom right play area 225 at the right hand edge, and a bottom left play area 226 at the left hand edge. Correspondingly, sub-triangle 222 comprises play areas 225, 227 and 228, and sub-triangle 223 comprises play areas 226, 228 and 229. Due to the partial overlap of the sub-triangles within the second order triangle 220, the play area 225 is shared between sub-triangles 221 and 222, play area 226 is shared between sub-triangles 221 and 223, and play area 228 is shared between sub-triangles 222 and 223. In total, 6 play areas are provided also within the second order triangle 220.

Similarly, looking at second order triangle 240, the upper sub-triangle 241 comprises a play area 244 at the upper edge, a bottom right play area 245 at the right hand edge, and a bottom left play area 246 at the left hand edge. Correspondingly, sub-triangle 242 comprises play areas 245, 247 and 248, and sub-triangle 243 comprises play areas 246, 248 and 249. Due to the partial overlap of the sub-triangles within the second order triangle 240, the play area 245 is shared between sub-triangles 241 and 242, play area 246 is shared between sub-triangles 241 and 243, and play area 248 is shared between sub-triangles 242 and 243. In total, 6 play areas are provided also within the second order triangle 240.

Correspondingly, looking at second order triangle 230, the lower sub-triangle 231 comprises a play area 234 at the lower edge, a top right play area 235 at the right hand edge, and a top left play area 236 at the left hand edge. Correspondingly, sub-triangle 232 comprises play areas 236, 238 and 239, and sub-triangle 233 comprises play areas 235, 237 and 238. Due to the partial overlap of the sub-triangles within the second order triangle 230, the play area 235 is shared between sub-triangles 231 and 233, play area 236 is shared between sub-triangles 231 and 232, and play area 238 is shared between sub-triangles 232 and 233. In total, 6 play areas are provided also within the second order triangle 230.

It has now been shown that each of the four second order triangles enclose three sub-triangles, making a total of 12 sub-triangles.

However, the main triangle, 200, is in this respect also considered a sub-triangle, whereby the play area 214 is shared between the sub-triangle 211 and the sub-triangle 200, play area 227 is shared between the sub-triangle 222 and the sub-triangle 200, and play area 249 is shared between the sub-triangle 243 and the sub-triangle 200. Thus, the main triangle 200 constitutes the 13th sub-triangle in the game platform.

In addition, three additional sub-triangles 250, 260 and 270 are provided overlying the three areas where edges of three second order triangles meet.

Thus, sub-triangle 250 is formed overlapping the lower right edge of the second order triangle 210, so that play area 217 is arranged at the upper edge of the triangle 250, the upper edge of the second order triangle 220, so that the play area 224 is arranged at the right hand edge of triangle 250, and the upper right hand edge of second order triangle 230, so that play area 237 is arranged at the left hand edge of triangle 250. To this end, and to obtain a more triangular shape for triangle 250, the play area 237 is preferably arranged somewhat displaced from the edge of the second order triangle 230, and sub-triangle 233.

By this arrangement, play area 217 is shared between the sub-triangle 212 and the sub-triangle 250, play area 224 is shared between the sub-triangle 221 and the sub-triangle 250, and play area 237 is shared between the sub-triangle 233 and the sub-triangle 250.

Similarly, sub-triangle 260 is formed overlapping the lower left edge of the second order triangle 220, so that play area 229 is arranged at the lower right edge of the triangle 260, the lower edge of the second order triangle 230, so that the play area 234 is arranged at the top edge of triangle 260, and the lower right hand edge of second order triangle 240, so that play area 247 is arranged at the left hand edge of triangle 260. To this end, and to obtain a more triangular shape for triangle 260, the play area 234 is preferably arranged somewhat displaced from the edge of the second order triangle 230, and sub-triangle 231.

By this arrangement, play area 229 is shared between the sub-triangle 223 and the sub-triangle 260, play area 234 is shared between the sub-triangle 231 and the sub-triangle 260, and play area 247 is shared between the sub-triangle 242 and the sub-triangle 260.

Similarly, sub-triangle 270 is formed overlapping the lower left edge of the second order triangle 210, so that play area 219 is arranged at the upper edge of the triangle 270, the upper edge of the second order triangle 240, so that the play area 244 is arranged at the lower left edge of triangle 270, and the upper left edge of second order triangle 230, so that play area 239 is arranged at the right hand edge of triangle 270. To this end, and to obtain a more triangular shape for triangle 270, the play area 239 is preferably arranged somewhat displaced from the edge of the second order triangle 230, and sub-triangle 232.

By this arrangement, play area 219 is shared between the sub-triangle 213 and the sub-triangle 270, play area 244 is shared between the sub-triangle 241 and the sub-triangle 270, and play area 239 is shared between the sub-triangle 232 and the sub-triangle 270.

By this arrangement, a total of 16 sub-triangles are provided, each having three distinct play areas, arranged at or in the vicinity of the edges. Thus, a totality of 24 play areas are provided, distributed over the game platform.

Each play area is further associated with two different sub-triangles.

Each play area is further associated with a color, selected from a group of three colors, and with a number, selected from the range 1-8. In the illustrated example, the three colors are blue, green and yellow. The combination of color and number is a unique identify for each play area. To this end, the numbers 1-8 occurs once in each color.

Further, each sub-triangle is preferably provided with three play areas all having different colors and different numbers. Further, each second order triangle preferably comprises a total of 6 play areas. These 6 play areas are preferably all assigned to different numbers and comprises two pairs of play areas of each color. The two play areas of each color are preferably arranged opposite to each other, so that one of the play areas occurs at an edge of the second order triangle, and the other in middle of the opposing vertex. Further, the play areas in the middle of the vertices being adjacent to each other by being arranged on two parallel and adjacent vertices of two different second order triangles are preferably of the same color, but with different numbers.

The numbers assigned to the play areas will in the following be referred to as Sit_order. Thus, there are 8 different Sit_orders, ranging e.g. from 1-8. The unique combination of color and number/Sit_order will in the following be referred to as Sit_number. Thus, there are 24 different Sit_numbers. Thus, every number in the Game-Platform is called a Sit_Number. Therefore, there are 24 Sit_Numbers throughout the Game-Platform. Moreover, each of the numbers 1 to 8 which has 3 Sit_Numbers in 3 different colors is called a Sit_Order.

In the exemplary embodiment, each play area is assigned a Sit_number in accordance with the following table:

| Sit_numbers | 1 | 2 | 3 | 4 | 5 | 6 | 7 | 8 |
|---|---|---|---|---|---|---|---|---|
| Blue | 214 | 218 | 224 | 228 | 234 | 238 | 244 | 248 |
| Yellow | 245 | 249 | 219 | 236 | 225 | 229 | 237 | 215 |
| Green | 226 | 235 | 247 | 217 | 246 | 216 | 227 | 239 |

In FIG. 2f, the common, shared play areas between different pairs of sub-triangles are illustrated.

Various ways of playing the game are possible, as will be discussed in more detail in the following. However, in many of these ways of playing the game, a goal is to assign all elements A-H to the Sit_Orders, each including 3 Sit_Numbers, so that all the available 24 Sit_Numbers are assigned to an element. This assignment is preferably made under the condition that the same elements cannot be assigned to more than one of the 5 Sit_Numbers which are placed in the edges of 2 sub-triangles where both are connected together by a common edge, as exemplified in FIG. 2d. Despite the fact that each element shall be arranged 3 times in 3 Sit_Numbers, a preferred general condition is further that any of these 3 same Elements do not get placed together among any of the 2 sub-triangles that are connected by a common edge.

A further condition is preferably that each element, from A-H, is only assigned to one number within each color group of the Sit_orders.

A further preferred condition is that the 3 Sit_Numbers belonging to a Sit_Order do not sit together in any of the 2 sub-triangles that are connected together by a common edge among all the 16 sub-triangles which form the Game Platform. In other words, by assigning each of the 8 Elements to each of the 8 Sit_Orders and subsequently put them into the Game Platform, result in none of the 5 Elements sitting in the edges of any 2 sub-triangles where they are connected together by a common edge are same.

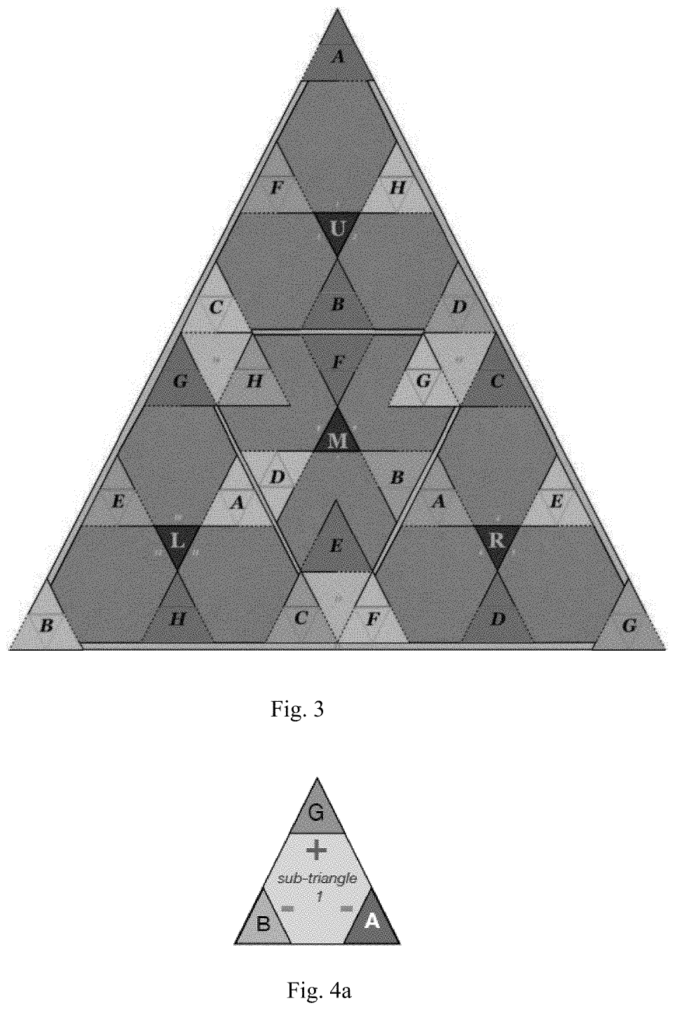

For instance, by assigning the Elements A-H to the Sit_Orders 1-8 in regular order, (Sit_Order 1=Element A; Sit_order 2=Element B; . . . ) the Game-Platforms looks as shown in FIG. 3.

The Game platform may be presented when the game is plaid, e.g. by being shown on a display, and the game platform is preferably continuously updated as the play evolves.

### Random Order

Since there is a set of 8 Elements {A,B,C,D,E,F,G,H} that should get arranged inside the Game Platform by assigning each of them to one of the Sit_Orders, due to the permutations of 8 objects, there will be 8!=40320 unique ways, permutations, to assign the 8 Elements among the 8 Sit_Orders. Every order of assigning Elements to the Sit_Orders is called a Random_Order. Therefore in this Game, there are 40320 unique Random_Orders.

In this Game, each Random_Order will be generated randomly, and preferably in an automated fashion, by a random number generator, preferably realized in software.

Therefore, by considering the fact that in every round each of the 8 Elements can get assigned just once to one of the Sit_Orders, the random sequence may be generated in an automated fashion, by randomly selecting one of the elements from the remaining elements in each round, to be assigned to each of the Sit_Orders. Thus, the first Element may be randomly generated from any of the 8 available Elements, the second one may be randomly generated from the remaining 7 Elements, the third Element may be randomly generated from the remaining 6 Elements, the fourth Element may be randomly generated from the remaining 5 Elements and so forth, up to the eighth Element which is the only remaining Element after randomly generating the previous 7 Elements.

### Game Rules

As mentioned above, after assigning each Element to a Sit_Order, an Element is assigned to each common edge of any 2 sub-triangles. In other words, every Element gets placed in 2 edges of 2 separate sub-triangles.

By combining 2 Elements together, a new figure, called a Shape, is created, as discussed in the foregoing.

For example, if Elements A, B and G are assigned at the playing areas at the edges of a sub-triangle, the situation will be as follows. Basically, in this Game, in the triangle version of it, the competition occurs between the Element within every sub-triangle. The competition is based on the competition in any combination of Elements, in pairs, within the sub-triangle. In this sub-triangle, the competitions will be: A+B, A+G and B+G. The result of this was discussed in relation to FIG. 1i above.

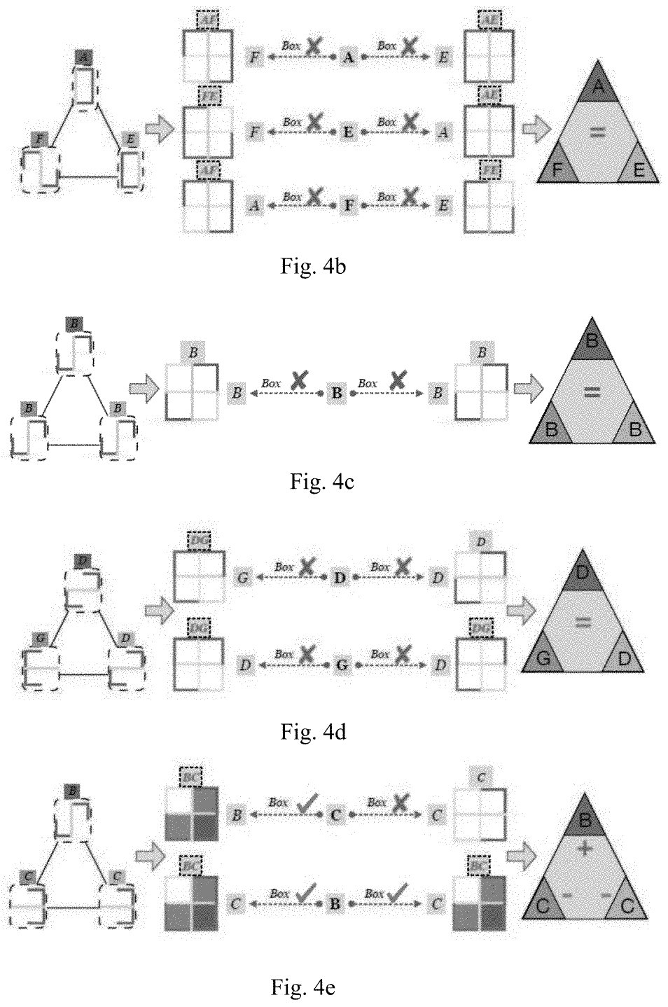

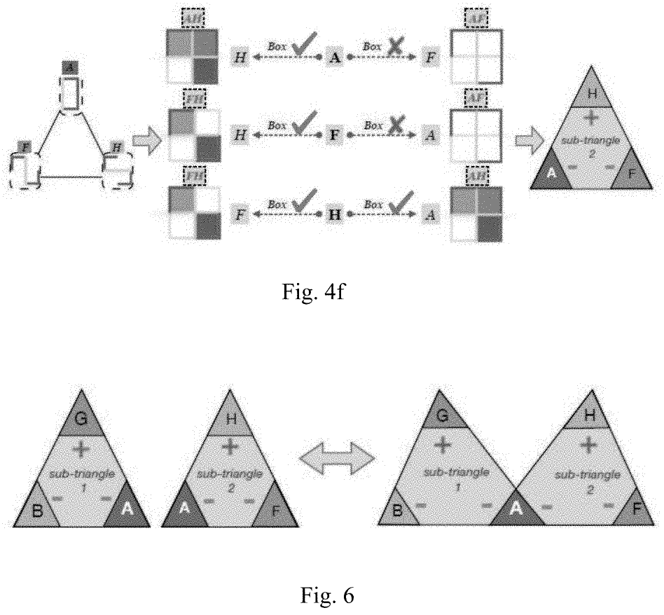

Thus, the result of this sub-triangle, as shown in FIG. 4a, is that Element G wins (+), whereas Elements A and B loses (−).

In the case that all of the 3 shapes obtained by combining the Elements of the sub-triangle in pairs results in equals, for example since all the shapes are lacking closed boxes, all the Elements are equal, as is the case for Elements A, F and E as shown in FIG. 4b. Thus, the result of this sub-triangle is a draw.

If all elements within a sub-triangle are the same, all the 3 elements would be equal to each other, since no element can create a shape with closed boxes by combining with itself. This situation is exemplified in FIG. 4c.

In a situation with two of the elements within a sub-triangle being the same, and the third being different, two situations may occur. The two identical elements cannot create a shape with closed boxes by being combined together. If combination with the third, different element also does not create any shape with closed boxes, all the combinations will be equal, and the result for the sub-triangle will be a draw. This situation is illustrated in FIG. 4d. However, if the combination with the third element creates a shape with closed boxes, the third element will win, as illustrated in FIG. 4e.

In FIG. 4f, the result of a sub-triangle comprising elements A, F and H is illustrated, where the result is that H wins.

The total number of possible combinations between any 3 elements in a sub-triangle, with respect to non-regular order (ABC=ACB=BCA=BAC=CAB=CBA), is 120, including the possibility of 2 or 3 identical elements in a sub-triangle.

The table in FIG. 5 shows all the possible Combinations between 3 Elements in any sub-triangle inside the Game platform with respect to non-regular order, both for a TV (triangle version) and a FV (face version) of the game. In addition, the table also clarifies for each combination (TV) and competition (FV) which element that wins (+) or loses (−), or result in a draw/equal (=) among that specific sub-triangle.

Due to the layout of the platform, as discussed in detail in the foregoing, each play area is associated with two different sub-triangles.

As an example, we may consider a first sub-triangle with elements G, B and A, and a second sub-triangle with elements H, A and F, where A is placed in a common play area, and is therefore common for the two sub-triangles. This situation is illustrated in FIG. 6. Here, the element A which is sitting in the common edge of the 2 sub-triangles, has reached 2 results, two losses.

Due to the layout of the platform, all the elements which get arranged among the Sit_Numbers, and consequently being assigned to a play area, throughout the Game platform, reach 2 results after the competition, since every element is sitting in the common edge/play area of 2 sub-triangles.

Thus, the result for each element assigned to a play area will one of the following:

a) The element wins in both sub-triangles.

b) The element wins in one sub-triangle and is equal in the other.

c) The element wins in one sub-triangle and loses in the other.

d) The element is equal in both sub-triangles.

e) The element loses in one sub-triangle and is equal in the other.

f) The element loses in both sub-triangles.

In an embodiment, the outcome of these results may be the following:
If a), the element may win the jackpot (JP), as will be discussed in more detail in the following.
If b), the element may win double the bet (×2), i.e. get the bet back, and an equal amount in addition to this.
If c) or d), the element may get back the bet (×1).
If e), the element may lose half the bet (×0.5), i.e. only get half the bet back.
If f), the element may lose the whole bet (×0).

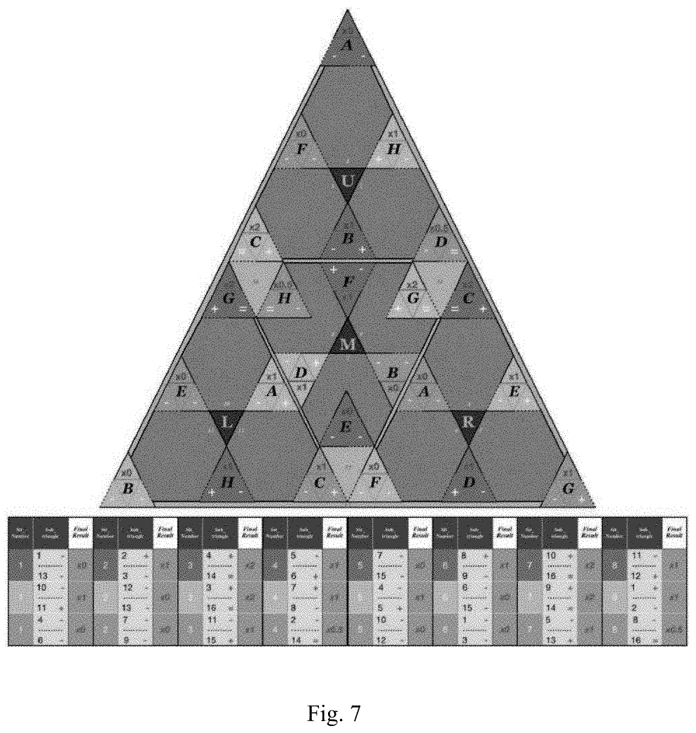

An illustration of this will now be given, with reference to FIG. 7, using the Sit_order assignment illustrated in FIG. 3, i.e. as follows:

| Sit_order | 1 | 2 | 3 | 4 | 5 | 6 | 7 | 8 |
|---|---|---|---|---|---|---|---|---|
| Element | A | B | C | D | E | F | G | H |

In each play area, the outcome is illustrated. For example, in play area 214 at the top, this play area is assigned with element A. The first sub-triangle including this play area is sub-triangle 211, including also elements F and H, and the second sub-triangle including this play area is 200, including also elements B and G. This results in two losses for element A, as indicated by the two “−” at the lower edges of the play area, and a total result of ×0, as indicated at the top of the play area. As another example, in play area 215, slightly below play area 214, this play area is assigned with element H. The first sub-triangle including this play area is sub-triangle 211, including also elements A and F, and the second sub-triangle including this play area is 212, including also elements B and D. This results in one loss and one win for element H, as indicated by the “−” and “+” at the lower edges of the play area, and a total result of ×1, as indicated at the top of the play area.

All the outcomes for the elements and play areas are further clarified in the table included in FIG. 7.

Each Sit_number will get one of the previously discussed conditions as its final result, based on its obtained element. The table below shows how many times and what percentage an element in a sub-triangle has of reaching each of the statuses throughout all possible 120 combinations:

| Element/ | | | | | | | | | Status |
|---|---|---|---|---|---|---|---|---|---|
| Status | A | B | C | D | E | F | G | H | percentage |
| Win | 10 | 10 | 10 | 10 | 10 | 10 | 10 | 10 | 27.8% |
| Equal | 10 | 10 | 10 | 10 | 10 | 10 | 10 | 10 | 27.8% |
| Loss | 16 | 16 | 16 | 16 | 16 | 16 | 16 | 16 | 44.4% |
| Total | 36 | 36 | 36 | 36 | 36 | 36 | 36 | 36 | |

However, as discussed in the foregoing, the final result for each element is in the end dependent on the combinations of that element in both sub-triangles where it gets arranged, i.e. the two sub-triangles having this edge as a common, shared play area. The table below summarized the conditions based on the 9 possibilities when considering both sub-triangles:

Sub-triangle 2

| Sub-triangle 1 | + | = | − |
|---|---|---|---|
| + | JP | x2 | x1 |
| = | x2 | x1 | x0.5 |
| − | x1 | x0.5 | x0 |

The following table summarizes the probability for each element of reaching any of the conditions, based on these possibilities:

| Outcome | Probability | Probability (%) |
|---|---|---|
| Jackpot (JP) | 1/9 | 11.11 |
| Double (x2) | 2/9 | 22.22 |
| Single (x1) | 3/9 | 33.33 |
| Half (x0.5) | 2/9 | 22.22 |
| Nothing (x0) | 1/9 | 11.11 |

Therefore, each element has one-third, or 33.33%, chance to achieve each status. In other words, an element has about 66.66% chance to either Win or achieve Equal as well as 33.33% chance to lose either half or the whole bet. Besides, the chance to win JackPot and the chance to lose the whole the bet (×0) are the same (11.11%).

By considering any 3 Elements which are sitting in the play areas of a sub-triangle, it follows that the statuses of those 3 elements in that sub-triangle consist of either 3 equals or 2 losses+1 win. Therefore, based on this fact and due to the Game platform design, the maximum possible number of every condition, regardless of the elements and Sit Numbers, can be estimated as below:

| JP | x2 | x1 | x0.5 | x0 |
|---|---|---|---|---|
| 8 | 12 | 16 | 18 | 16 |

### Game Table Layout

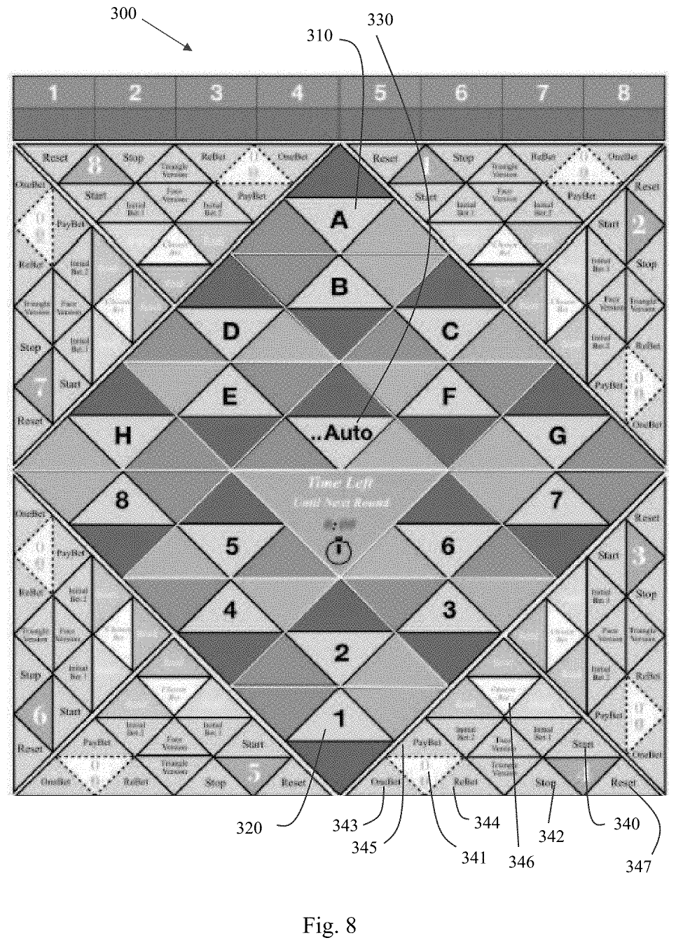

An embodiment of a game table layout for placing bets in the game is illustrated in FIG. 8. The game table may be a physical table with a print on it, onto which betting chips are placed in desired areas for placing bets. However, the game table is preferably presented on a display, such as on an interactive touch display, or being presented on a computer screen, on a smartphone, on a tablet or the like. Thus, the word “table” here relates to a two-dimensional layout, which may be realized as a physical table, but may also be realized as an image on a display or the like. However, the game platform may also be realized as a pyramid, enabling e.g. for online players to choose the view of the platform between 2D and 3D. However, for the physical game, e.g. at a casino, it is more convenient to have the platform realized as a 2D-based table, but even here it is possible to design the table game as a pyramid as well, i.e. as a 3D realization of the table.

The game table may be designed in various ways, as long as it allows bets to be placed easily and in an easily recognizable way.

In the illustrated embodiment, the game table, which may also be referred to as “betting card”, is shaped as a square, divided by diagonally running lines, indicating distinct areas. Centre of the board comprises areas to indicate bets made, where about one half is arranged for bets placed on elements (A-H), and possibly also different colors, whereas about one half is arranged for showing bets on Sit_orders, and possibly also different colors. At the very center, there may be areas for showing automatic bets.

At the outer periphery of the game table, there are 8 places for player interaction, also referred to as nodes. In this embodiment, each of the player interaction areas are triangular, and two such player interaction areas are situated at each corner of the table.

Further details of the layout of the game table, and how the table is used, will become apparent from the following detailed description of various ways of playing the Game.

### Making Bets and Playing the Game

The Game can be played in various ways, allowing the player to play by chance only, or to rely on skill and expertise as well. In the following, some specific ways of playing the game will be discussed in further detail, relating to various classes in which a player may enter the Game.

### Luck Class.1 (L1)

In this class, the players bet on odds based on their luck. Periodically, such as every 6 minutes, a new round of this class starts. Thus, each Tournament, to be discussed in more detail in the following, typically lasting for an hour, may include 10 rounds of this class.

Live countdown timers may be present to show the remaining time of every Tournament. In addition, for this Class, there may also be another live countdown timer for each round which shows the time left before the next rounds starts.

In addition, the players can play as many rounds as they want during the same Tournament, but at a maximum 10 rounds.

The Game table layout is specifically designed for this class of the Game.

The game table 300, as shown in FIG. 8, comprises 8 betting objects which are predefined by numbers 1 to 8. By paying one initial bet, the player is allowed to place a bet on one of the elements or Sit_orders. By this, the player in fact places 3 bets in each site, on either an element or a Sit_Order or ‘Auto’ in all its 3 colors. Therefore, the amount of the initial bet gets divided by 3, whereby each of the 3 bets gets its portion of the initial bet. Moreover, in a round, for each playing card the players are allowed to place bets on all the 8 elements/Sit_orders at the same time. However, in this class, the Game preferably starts simultaneously for all players.

Generally, for every site, the player is able to place 3 bets on the 3 colors belong to an element or a Sit_Order, or on “Auto”, based on one of the following 3 modes.

In a first mode, the player may bet on an element. If the player wants to place a bet on an element, he has to choose one of the 8 elements, represented by element sites 310. As a matter of fact, by choosing one element, the player hereby places 3 bets on the 3 colors of that particular element.

When the Game starts in a round, the system primarily generates a random order and then, by putting that set into the table of Sit_Order, all the 8 Elements obtain their 3 Sit_Numbers. Therefore, every Sit_Number gets replaced by the assigned element throughout the Game platform, by applying the conditions discussed above, the player reaches one result for each bet (color).

In a second mode, the player may bet on a Sit_Order. If the player wants to bet on a Sit_Order, he has to choose one of the 8 Sit_Order sites 320. As a matter of fact, by choosing one Sit_Order, the player actually place 3 bets on all the 3 Sit_Numbers which belong to that Sit_Order.

When the Game starts in a new round, the system primarily generates a random order and then, by putting that set into the table of Sit_Order, the 3 Sit_Numbers belonging to every Sit_Order obtain that Element as well. Therefore, every Sit_Number gets replaced by the assigned element throughout the Game-platform, and based on the above-discussed conditions, the player reaches one result for each bet (color).

In a third mode, the player may place an automatic bet, by betting on “Auto”. Thus, for more convenience, the players are able to choose the “Auto” site, 330, rather than choosing an Element or a Sit_Order.

As shown in the game table, each player area has its own start button 340. Hereby, when a player wants to participate in a round, after placing his bet on an element or a Sit_Order or ‘Auto’ in any of the sites, he has to click on the start button 340 during the 6-minute period before the round begins.

When the player places a bet on “Auto” and then clicks on the start button 340, the system issues an identity number called Auto-ID to that bet. The Auto-ID may contain 2 different parts:
Node_Number: As mentioned above, each node has a predefined number called a node_Number.
Time_Stamp: This number is related to the time the bet was made, and may e.g. be the exact time in seconds that remained before the next round would start when the player clicked on the start button. A new round would typically start every 6 minutes, i.e. every 360 seconds, and the live countdown timer shows the time that remains until the next round starts. At the moment when the player clicks on the start button, the time remaining until start of the next round will be registered and used as part of the Auto-ID associated with that particular bet on “Auto”. For instance, if the TimeCountdown shows 4:32 as the time remaining until the start of the next round when the player clicks on the start button for a bet on “Auto”, the number that will be registered as the Time_Stamp may be: 4 (m)×60 (s)+32 (s)=272.

For each bet on ‘Auto’ the system preferably registers first the Node_Number and then the Time_Stamp as the bet's Auto-ID. For instance, in the example above if the Time_Stamp for an “Auto” bet in Node position 3, the Auto-ID may be registered as: 3272.

Before a round starts, every Sit_Order and every Element may have their own station called Cluster where the bets on a Sit_Order are arranged inside the Cluster which belongs to that Sit_Order and on the other hand, the bets on an Element are arranged inside the Cluster which belongs to that Element. Therefore, based on the 8 Sit_Orders, there are 8 Clusters with a number 1 to 8, each of which is dedicated to the Sit_Order with the same number, and in addition, based on the 8 Elements, there are another 8 Clusters with a letter A to H, dedicated to the Elements with the same letter.

In addition to these 16 Clusters, and due to the fact that the bets on “Auto” do not have any Element or Sit_Order before the round starts, these bets are arranged in a separate Cluster with the Number 0 in descending order based on their Auto-ID.

When the Game starts and a random order is generated, all the players who chose Elements obtain their Sit_Numbers and all the players who chose Sit_orders obtain their Elements. Hereby, the system integrates every element's Cluster into the assigned Sit_Order's Cluster, and consequently there will be just the 8 Clusters which belong to Sit_Orders remaining.

At this time, the system can recognize the number of bets on each Sit_Order. Thereby, in order to reach an equivalent number of bets between the Sit_Orders, the system may spread the bets on “Auto” among any Sit_Order which needs more bets in comparison with the other Sit_Orders. To create the best randomized way of spreading these bets based on the generated random order in each round, the 8 Elements are preferably divided into 2 groups: an odd group which includes the Elements [A-C-E-G] and an even group which includes the Elements [B-D-F-H]. As mentioned before, by putting the generated random order inside the “Table of Sit_Order”, every Element gets assigned by a Sit_Order. Hereby, the presumption for spreading the bets from Cluster 0 among the other Clusters, based on the descending order of bets inside the Cluster 0, is that the 4 Sit_Orders Clusters with odd group's Elements take the bets from bottom of the Cluster 0 and the other 4 Sit_Orders Clusters with even group's Elements take the bets from top of the Cluster 0. The number of bets which each Sit_Order's Cluster is allowed to take is completely dependent on the number of already available bets inside each Cluster in relation to the number of bets inside the Cluster 0, in order to reach an equivalent number of bets between the Clusters belonging to the 8 Sit_Orders. Therefore, in result, the bets on “Auto” obtain both Elements and Sit_Numbers as well.

This version/class of the game can be played in the Face Version or Triangle Version.

In the Face Version: By choosing this Version of L1 for a Node, the Initial-Bet is being split into 3 bets where at the end of a round, each bet gets its own result (Condition) based on the chosen Element's diagonal, as mentioned before.

In the Triangle Version: By choosing this Version of L1 for a Node, the Initial-Bet is not being split, and at the end of a round, all the 3 bets get just one result together. Hereby, between the players who could create at least 14 primitive squares or triangles (U-R-M-L) among the winning Elements inside their chosen Triangle:
The player with the highest number of triangles, wins JackPot (JP)
The player with the second highest number of triangles, wins double the bet (×2)
The player with the third highest number of triangles, gets back whole the Initial-Bet (×1)
The player with the fourth highest number of triangles, gets back half of the Initial-Bet (×0.5)
The player with the least number of triangles more than 14, lose the whole Initial-Bet (×0)

It should be appreciated by the skilled reader that for each player the number of triangles is being counted among any of the 3 Elements belonging to him which either got Win or Lose result in any of their sub-triangles. In case of winning in a sub-triangle, it means that that Element could create a Shape including 1 or 2 triangles in combination with each of the other 2 Elements among that particular sub-triangle and in case of losing in a sub-triangle, it means that that Element could however create a Shape including 1 or 2 triangles in combination with just the winning Element among that particular sub-triangle.

Moreover, for the same Initial-Bet, the Winning amount for a Bet in this Version (JP or ×2) is equal to the same Condition of just 1 of the 3 bets in the Face Version and on the other hand, the Equal (×1) or Losing (×0.5 & ×0) amount is equal to the same Condition of all the 3 bets in the Face Version. For instance, a SEK 12 Bet in Face Version where all the 3 bets get ×2 Condition earns: SEK12 (the Initial-Bet)+[3×SEK 4]=SEK 24 while the same Bet in Triangle Version that get ×2 as its result earn: SEK 12 (the Initial-Bet)+[1×SEK 4]=SEK 16.

The players can decide whether they are willing to play in more rounds without the necessity to be online through the following options:

As a default option for all the 8 playing areas at the table, unless a player changes it, is that after clicking on the Start button his bet will attend only the upcoming round and when that round is finished, regardless of the result of the 3 bets, the player, if he is willing to participate with the same Bet in the next round as well, has to click on the Start button again. This option may be referred to as OneBet.

As an alternative option, which may be selected by a player, any of the 3 bets which still has a sufficient portion of the Initial-Bet remaining by winning or getting equal in a round will continue to attend the next rounds automatically as long as a sufficient portion of the initial bet remains after participating in each round. Therefore, based on the fact that by placing one initial bet the player actually gets 3 bets, it is possible that due to the separate result of each bet, all the 3 bets or maybe 1 or 2 of them, win(s) or get(s) equal, and as a consequence, these bet(s) will continue into the next round automatically. This option may be referred to as ReBet.

As yet another option, the player is able to allocate a desired amount of money for a bet. Therefore, that bet will participate upon the next rounds regardless of the 3 bets results after each round as long as the whole allocated amount of money for that particular bet has not been completely spent on the initial bet for those 3 bets. This option may be referred to as PayBet.

The white triangle 341 at each node/play area, which is surrounded by the 3 Bet_Options 343-345 is called Node-Balance, and includes 2 values: The top value, in blue, which represents the whole part of Initial-Bet/Allocated amount and the bottom value, in red, which represents the remaining part of Initial-Bet/Allocated amount. When the player places his bet and then chooses OneBet 343 or ReBet 344, by clicking on the Start button 340, the whole amount of Initial-Bet is withdrawn from the player's account which appears as the top value in the Node-Balance. On the other hand, by choosing the PayBet 345, the player has to enter the amount that he wants to allocate for that Bet in the top value of the Node-Balance and then by clicking on the Start button 340, the allocated amount is withdrawn from the player's account.

During the 6 minutes before the round starts, a player can finalize the participation of his node by clicking on the Start button 340. On the other hand, he can cancel the participation of his node by clicking on a Stop button 342 before the next round starts. Furthermore, when a round is finished, the result of each attended bet appears in the result section 346 of every Node. In the illustrative example, the result section contains 3 triangles in 3 different colors, surrounding a fourth white triangle, where each colored triangle represents a bet. Therefore, each bet's result appears in the triangle with the same color.

If a bet is made on “Auto”, and when the player has chosen PayBet or ReBet, all or some of the 3 bets might participate in the next round automatically. The Auto-ID for the next round may be based on the previous Time_Stamp by adding 360 to this, and this sum may then be registered as a new Time_Stamp in the Time_Stamp section of the Auto-ID for that bet in the next round. Furthermore, the system may repeat these steps in every next round for the bets on “Auto” where all or some of the bets will be participating in a next round based on the chosen bet-options. This is further exemplified below:
1st round bet's Auto-ID: 2 (Node_Number)+1:57 (Time_Stamp)=2117
2nd round bet's Auto-ID: 2 (Node_Number)+[1:57+360 (Time_Stamp)]=2477
3rd round Bet's Auto-ID: 2 (Node_Number)+[1:57+360+360 (Time_Stamp)]=2837

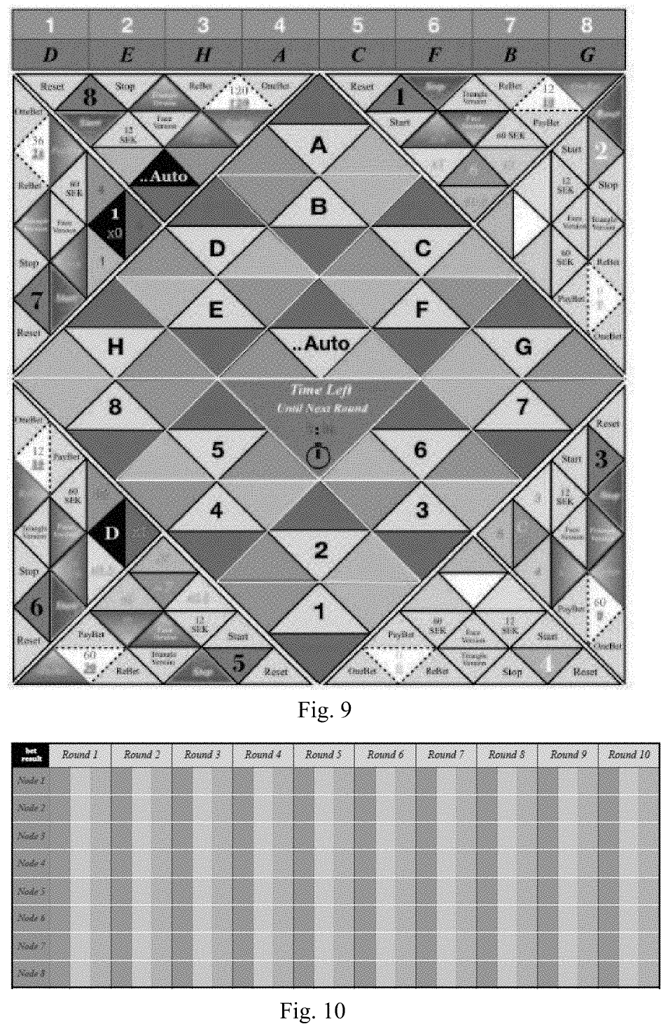

In FIG. 9, an example is provided to illustrate how the 8 Nodes in the Game table are used when playing the Game.

The player at Node 1, at the top right corner, placed an initial bet of 12 SEK on the Sit_Order 6 through Face Version with OneBet as the Bet_Option in the last round. The condition of each bet appears in the result triangle of the node inside each triangle with the same color. For instance, the bet on green 6 reached the condition ×1 as the result. Despite the fact that 2 of the bets got equal, based on the chosen Bet_Option (OneBet), none of the 3 bets will automatically participate in the next round, and therefore the Stop button turns to red. Despite the fact that this Node does not participate automatically in the next round, the remaining amount of the initial bet still belongs to this Node and is shown in the node balance until either the player clicks on the Reset button 347 or the 6-minute period of the next round is over, whereby in both cases the node will be restored and the remaining amount of initial bet will be transferred to the player's account. However, if the player wants to place the same bet in this Node again to participate in the next round as well, he just needs to click on the Start button once again.

The player at Node 2, just below Node 1, clicked on the Reset button, and consequently the node has been completely restored and in case there was any remaining amount of the initial bet in the node balance, this has now been transferred to the player's account.

The player at Node 3, at the bottom right corner, has placed a bet of 60 SEK on the Element C, with the Triangle Version, with ReBet as the Bet_Option. After the last round, due to the bets' results (×0), the initial bet does not remain, and consequently, despite the choice of ReBet, this bet will not participate automatically in the next round. Therefore, the node's stop button turns to red. The number inside the result triangle represent the number of built closed boxes/triangles through each of the 3 edges (in the 3 colors) belonging to that bet.

Node 4, right below Node 3, has not placed any bet in the last round.

Node 5, at the bottom left corner, placed a bet of 60 SEK on “Auto” with through the Face Version, and with OneBet as the Bet_Option in the last round. It can be easily recognized that based on the Random_Order generated for the previous round, the system assigned the Sit_Order 7 to that Node. Despite the bet with JP, which has maintained its portion of the initial bet, this bet will not participate in the next round, and the Stop button turns to red. In case that the player wants to place the same Bet in this Node again to participate in the next round as well, he just needs to click on the Start button once again, which according to the remaining amount of Initial-Bet in the last round (30 SEK) the system withdraws 30 SEK from the player's account. Due to the result of the bet in the previous round, and because the node still keeps the amount of its initial-bet during the 6-minute period until the next round or until the player himself clicks on the Reset button, by clicking on the Start button again, the system withdraw the initial-bet from the amount which is still being kept by that particular node, and not from the player's account.

The player at Node 6 has placed his bet of 12 SEK on the Element D through the Face Version with ReBet as the Bet_Option. After the last round, due to the bet results—two bets have still their parts of the initial bet remaining (the bottom value 10 shown in the node balance represents 10 SEK as the 2 bets portions plus one bet half portion of the initial bet)—which consequently means that these 2 bets will continue to participate in the next round as well and therefore, the Node's Start button is still in red.

The player at Node 7 has placed his Bet of 12 SEK on the Sit_Order 1 through the Triangle Version with PayBet as the Bet_Option. The top value in the Node-Balance (36 SEK) represents the allocated amount by the player to this Bet. Due to the bet result (×0) in the previous round, the system withdrew 12 SEK as the initial bet for the next round from the allocated part, and consequently, the remaining amount (36-12=24 SEK) is shown in the bottom value. However, the bets will continue to participate in the next rounds as long as the whole allocated amount is not finished. Once again, the numbers inside the result triangle represent the number of built closed boxes/triangles through each of the 3 edges (in the 3 colors) belonging to that bet.

The player at Node 8 has placed his Bet of 60 SEK on “Auto” through the Triangle Version, with PayBet as the Bet_Option. The top value in the Node-Balance (120 SEK) represents the allocated amount by the player to this bet, and since this node has not participated in any round yet, the bottom value (120 SEK) represents the same amount as the allocated amount.

Generally, the players can stop the participation of their nodes to the next round at any time before the round starts by simply clicking on the Stop button. Despite the functionality of the Stop button which cancel the participation of the node in the next round, the system will still keep showing the latest options such as the Initial-Bet/allocated amount, the Bet_Option and the Bet that were chosen by the player before clicking on the Stop button. In this case, by clicking on the Reset button during the 6-minute period, all the options chosen for that Node will be restored and the Initial-Bet or the allocated amount transferred to the player's account, as seen e.g. in Node 2 in the example above. However, all the non-participated Nodes in the next round get reset by the system anyway after the 6-minute period of that round is over.

Furthermore, as shown in the table in FIG. 10, for this Class the bet results of a Tournament may be presented in the form of the illustrated table, presenting the bet result for all the 8 Nodes participating in any of the 10 rounds.

Generally during a Tournament, only the table of bet result which is related to the current Tournament is presented. However, the system preferably also saves the tables of bet result belong to a number of previous tournaments, such as the last 10 tournaments.

In the table below, samples of 10 Random_Orders applied to the Game platform is presented. The numbers in the table represent the number of Sit_Numbers which got each Condition based on every Random_Order.

| | A-B- | D-E- | H-C- | E-F- | G-D- | B-G- | C-A- | F-H- | A-F- | B-C- |
|---|---|---|---|---|---|---|---|---|---|---|
| | C-D- | H-A- | D-B- | A-B- | B-F- | F-C- | G-H- | C-E- | G-E- | E-F- |
| Condi- | E-F- | C-F- | F-A- | G-H- | A-E- | H-D- | B-E- | D-G- | B-H- | D-A- |
| tion | G-H | B-G | G-E | C-D | H-C | E-A | D-F | A-B | C-D | H-G |
| JP | 0 | 1 | 0 | 0 | 2 | 0 | 2 | 0 | 1 | 0 |
| x2 | 4 | 3 | 5 | 0 | 2 | 4 | 5 | 5 | 4 | 2 |
| x1 | 10 | 8 | 9 | 16 | 8 | 9 | 5 | 9 | 8 | 12 |
| x0.5 | 2 | 6 | 1 | 0 | 4 | 5 | 1 | 1 | 2 | 4 |
| x0 | 8 | 6 | 9 | 8 | 8 | 6 | 11 | 9 | 9 | 6 |

For instance, by assuming that the system has chosen the first Random_Order in the table above (A-B-C-D-E-F-G-H), the example in FIG. 7 illustrates the result of applying this Random_Order into the Game-Platform, and showing the 2 statuses and the Condition of every Sit_Number.

### Luck Class.2 (L2)

Like the Game in the class L1, the players in this class bet on odds based on their luck. However, unlike the class L1, the Game in this class is solo which basically means that every player can start to play whenever and as many rounds as he wants during a tournament. In this class, the players bet on the second order triangles. Therefore, by paying one Initial-Bet, the player in fact places 6 bets on the 6 Sit_Numbers inside any Triangle.

An example of this is illustrated in FIG. 11a. Generally, when a player places a bet on one of the 4 Triangles (U-M-L-R), by clicking on the Start button a Random_Order is generated which is applied to the Game platform. Then, the conditions of all the Sit_Numbers are determined. Therefore, based on the 6 available Sit_Numbers in the player's chosen Triangle, he can see the result of each bet. Furthermore, the player is allowed to place up to 4 Initial_Bets (24 bets) at the same time and in the same round in this Class. For instance, by assuming that the system generated the Random_Order as {D-E-H-A-C-F-B-G} and then applied that to the Game platform, each bet in every triangle gets its result as shown in FIG. 11a.

FIG. 11b illustrates a combined game platform and game table, which can be used for example when playing this luck class versions of the game.

In the Face Version: By choosing this Version of L2 for a Node, the Initial-Bet is being split into 6 bets where at the end of a round, each bet gets its own result (Condition) based on the chosen Element's diagonal, as mentioned before.

In the Triangle Version: By choosing this Version of L2 for a Node, the Initial-Bet is NOT being split where at the end of a round, all the 6 bets get just one result together. Hereby, between the players who could create at least 14 primitive square's triangles (U-R-M-L) among the winning Elements inside their chosen Triangle:
The player with the highest number of triangles, wins JackPot (JP)
The second player with the highest number of triangles, wins double the bet (×2)
The third player with the highest number of triangles, gets back whole the Initial-Bet (×1)
The fourth player with the highest number of triangles, gets back half of the Initial-Bet (×0.5)
The player with the least number of triangles more than 14, lose the whole Initial-Bet (×0)

It should be emphasized that for each player the number of triangles are being counted among any of the 6 Elements inside his chosen Triangle which got just Win result in any of their sub-triangles. By winning in a sub-triangle, it means that that Element could create a Shape including 1 or 2 triangles in combination with each of the other 2 Elements among that particular sub-triangle.

Moreover, for the same Initial-Bet, the Winning amount for a Bet in this Version (JP or ×2) is equal to the same Condition of just 1 of the 6 bets in the Face Version and on the other hand, the Equal (×1) or Losing (×0.5 & ×0) amount is equal to the same Condition of all the 6 bets in the Face Version! For instance, a $6 Bet in FV that all its 6 bets got ×2 Condition earns: $6 (the Initial-Bet)+[6×$1]=$12 while the same Bet in TV that got ×2 as its result earn: $6 (the Initial-Bet)+[1×$1]=$7.

Furthermore in this Class, by considering the fact that there is no such a 6-minute waiting time for starting a round and due to the explanation of ReBet and PayBet, when a round finished in this Class and so the results are clear, due to the chosen Version of the game (FV or TV), if there is any Bet/bet among the 4 Nodes which is eligible to participate in the next round automatically, then after just 6 seconds, the system generates another Random_Order for that particular Node. Furthermore, in case that a player is willing to bet on more than one Node at the same time in a round, by just clicking on his desired Nodes numbers first and then by clicking on the Start button belonging to any of those Nodes, he can in fact activate simultaneously those Nodes where in result, the system will generate obviously just one Random_Order for those specified Nodes.

### Skill Class.1 (S1)

The Game in this class is intended for players who wants to bet more based on their skill, and not only based on luck. In this class every 8 players compete against each other in the same Game platform. Each player chooses one of the 8 available Elements. When the 8 players have gathered in the same Game platform and each player has chosen one of the 8 available elements, the Game starts by generating a Random_Order just for that particular Game-Platform. Then, by putting that set of elements into the “Table of Sit_Orders”, the 3 Sit_Numbers for every element will be determined, and consequently each player obtains 3 Sit_Numbers based on the chosen element. Therefore, by paying one Initial-Bet, the player in fact places 3 bets on the 3 Sit_Numbers which belong to a Sit_Order.

In addition to the Sit_Order which is assigned to an Element chosen by the player, which includes 3 Sit_Numbers, every player gets 6 additional elements to choose from. These 6 choices of elements belonging to every player is called a Sit_Hand. Hereby, each player obtains 2 kinds of Elements:
T.Element: Based on the generated Random_Order which assigns a Sit_Order to every player based on his chosen element, the 8 players are divided into 2 teams, one team of odds and one of evens. The even team contains the players who got an even number (2-4-6-8) as their Sit_Orders and the odd team contains the players who got an odd number (1-3-5-7) as their Sit_Orders. Thereby, the players in each team also gets the chosen elements by the other players in that team. In other words, based on the Random_Order that is generated for those 8 players and due to the Table of ‘Sit_Orders’, the players with the Sit_Orders: {2-4-6-8} obtain each other's chosen elements and the players with the Sit_Orders: {1-3-5-7} obtain each other's chosen Elements as well. Therefore, every player also obtains 3 Elements which were chosen by the other 3 players in the same team. These 3 Elements are called T.Elements (T stands for team in this class). Furthermore, every player is allowed to assign each of his 3 T.Elements just once to one of his 3 Sit_Numbers.
P.Element: In addition, the player can assign his own chosen Element to all his 3 Sit_Numbers as well. The chosen Element by the player that can get assigned 3 times is called P.Element (P stands for player). Therefore, every player obtains his own Sit-Hand which includes 6 Elements (3 T.Element+3 P. Element).
   In the Face Version: If a player chose to play in this Version of S1, his Initial-Bet is being split into 3 bets where at the end of a round, each bet gets its own result (Condition) based on the chosen Element's diagonal, as mentioned before.

When the game starts, from the first Triangle due to the turn order based on the generated Random_Order, in the Level 1 the player who has the lower Sit_Number in blue starts the game by choosing an Element within the same sign as the sign of playing Triangle. If he does not have any, he puts his P.Element instead. Then the other player who has the higher Sit_Number in blue on that same playing Triangle chose an Element in the same way. When the Level 1 is finished, the Level 2 starts from that first Triangle, due to the turn order, again. Hereby, the player who has the lower Sit_Number in yellow choose an Element based on one of the 2 Elements signs in the previous Level (2 Sit_Numbers in blue) where that Sit_Number in yellow is sitting in the common edge of their sub-triangles (for instance, to choose an Element for 7, the player has to look at the signs of Elements in 3 & 6). In case he doesn't have any Element with the same sign as one of those 2 Elements, he has to choose his P.Element instead. When the Level 2 is finished, the Level 3 starts from that first Triangle, due to the turn order, in the Game-Platform. Hereby, the player who has the lower Sit_Number in green choose an Element based on one of the 2 Elements signs in the previous Level (2 Sit_Numbers in yellow) where that Sit_Number in green is sitting in the common edge of their sub-triangles (for instance, to choose an Element for 4, the player has to look at the signs of Elements in 7 & 8). In case he doesn't have any Element with the same sign as one of those 2 Elements, he has to choose his P. Element instead.

Furthermore, in any of these 3 Levels, when the player has to choose his P.Element instead, if his P.Element has the same sign as the sign of playing Triangle, then he can choose any other desired Element instead.

Therefore, each Sit_Number belonging to a player gets its own result as well as part of the Initial-Bet.

In the Triangle Version: If a player chose to play in this Version of S1, his Initial-Bet is NOT being split where at the end of a round, all the 3 bets get just one result together. There is no rule in this Version of the game to pickup an Element! Hereby, between the players who could create at least 14 primitive closed boxes/triangles (U-R-M-L) among their both winning and losing Elements:
The player with the highest number of triangles, wins JackPot (JP)
The second player with the highest number of triangles, wins double the bet (×2)
The third player with the highest number of triangles, gets back whole the Initial-Bet (×1)
The fourth player with the highest number of triangles, gets back half of the Initial-Bet (×0.5)
The player with the least number of triangles more than 14, lose the whole Initial-Bet (×0)

It should be emphasized that for each player the number of triangles are being counted among any of the 3 Elements belonging to him which either got Win or Lose result in any of their sub-triangles. In case of winning in a sub-triangle, it means that that Element could create a Shape including 1 or 2 triangles in combination with each of the other 2 Elements among that particular sub-triangle and in case of losing in a sub-triangle, it means that that Element could however create a Shape including 1 or 2 triangles in combination with just the winning Element among that particular sub-triangle.

Moreover, for the same Initial-Bet, the Winning amount for a Bet in this Version (JP or ×2) is equal to the same Condition of just 1 of the bets in the Face Version and on the other hand, the Equal (×1) or Losing (×0.5 & ×0) amount is equal to the same Condition of all the 3 bets in the Face Version! For instance, a JPY 600 Bet in FV that all its 3 bets got ×2 Condition earns: JPY 600 (the Initial-Bet)+[3×JPY 200]=JPY 1200 while the same Bet in TV that got ×2 as its result earn: JPY 600 (the Initial-Bet)+[1×JPY 200]=JPY 800. By assuming that more than one player have reached the same number of triangles (Min. 14), all of them wins the same result.

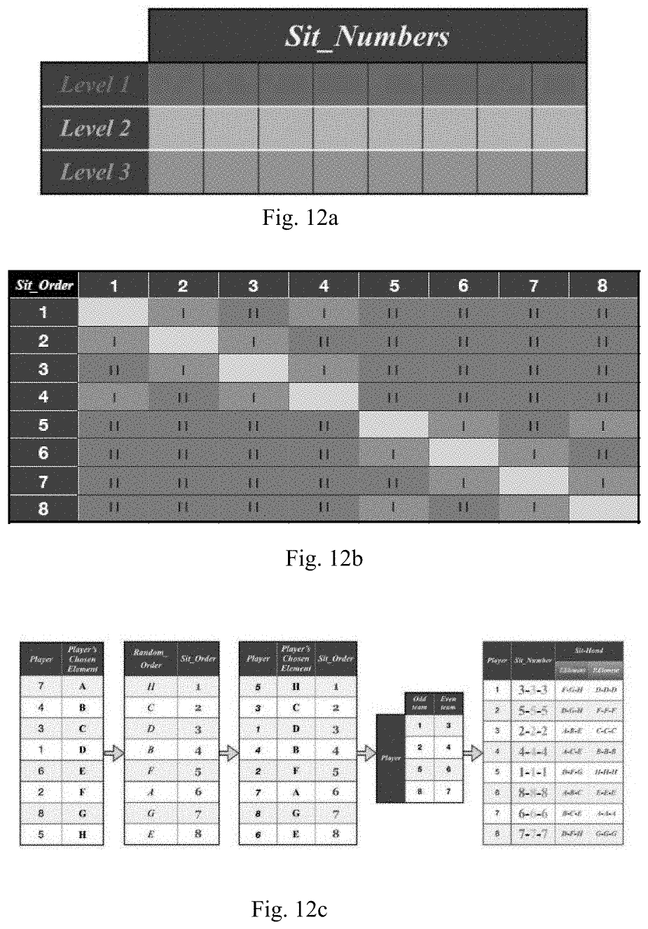

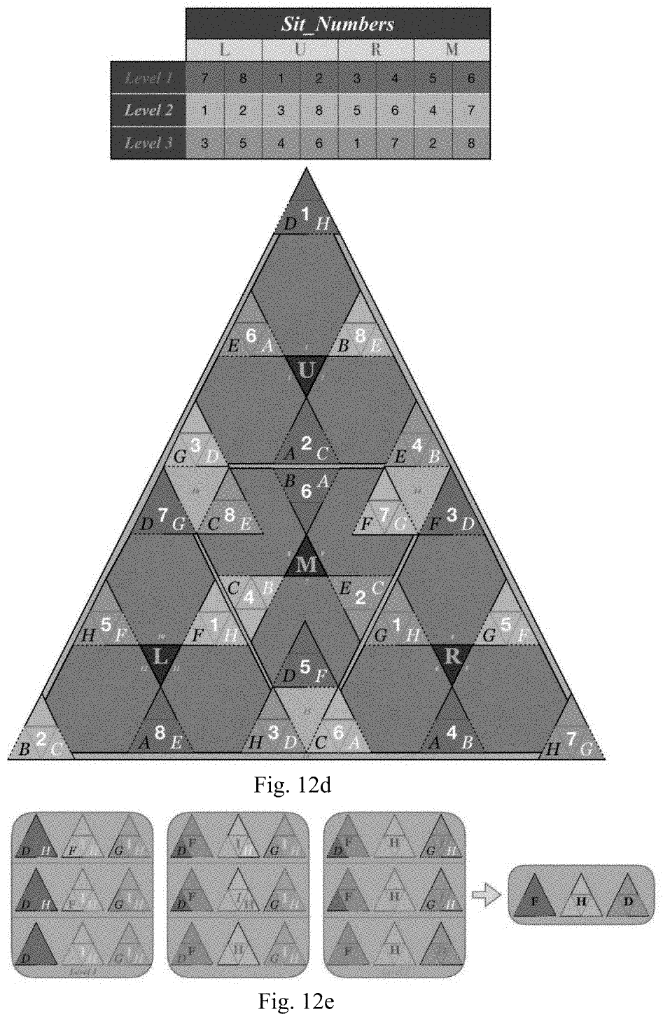

In this class, the 8 players compete against each other in 3 different levels where each level contains the 8 Sit_Numbers with the same color throughout the Game platform, as illustrated in the table shown in FIG. 12a. The Sit_Numbers are constant at each level, and are dependent on the turn order, based on the generated Random_Order that determines the order of Sit_Numbers at each level.

The Game starts at Level 1 and ends at Level 3. In this Class, the order of playing inside the Game-Platform is based on the order of Triangles, or in fact Elements signs toward a Random_Order. For instance, if the system generates the set: {B-H-E-F-C-A-D-G} as the Random_Order, by considering each Element's sign, then {B (R)-H (L)-E (M)-F (L)-C (U)-A (U)-D (R)-G (M)} which results in the order of playing game among the 4 Triangles inside the Game-Platform as: R-L-M-U.

When all the 8 players have got their Sit_Numbers based on their chosen elements, the Game starts at Level 1. When it is a player's turn, he has only a predetermined time, such as 10 seconds, to choose an element for his Sit_Number. If no choice is made in time, the system will automatically assign the player's P.Element to that particular Sit_Number. Therefore, each level in this class takes no more than 2 minutes and 40 seconds from the moment after that the 8 players with their chosen elements are present and the system generated a Random_Order. However, a player may, after having chosen the desired element for his Sit_Number, skip the remaining time of the 10-second period by pressing a “Pass” button. Moreover, if without choosing any Element, the player clicks on the “Pass” button anyway, the system will assign the player's P.Element to that particular Sit_Number instead.

Based on the special design of the Game-Platform, every player through his 3 Sit_Numbers competes in fact with all the other 7 players. Due to the fact that every Sit_Number sits in the common edge of 2 sub-triangles and competes against 4 other Sit_Numbers, each Sit_Order, through its 3 Sit_Numbers, competes against all the other 7 Sit_Orders, through their 12 Sit_Numbers. In other words, by considering every Sit_Number which is sitting in the common edge of 2 sub-triangles and competes against 4 other Sit_Numbers, each Sit_Order through its 3 Sit_Numbers competes against 12 other Sit_Numbers which belong to other 7 Sit_Orders. Hereby, a Sit_Order through its 3 Sit_Numbers compete against 2 Sit_Numbers of every 5 Sit_Orders and 1 Sit_Number of every 2 other Sit_Orders, as represented in the table shown in FIG. 12b, where I represents 1 Sit_Number and II represents 2 Sit_Numbers of the Sit_Order.

Furthermore, all the 8 players have precisely the same odds in every level:
In Level 1, there is no element present in any of the sub-triangles, where every Sit_Number belonging to this Level is located in the common edge of two of the sub-triangles.
In Level 2, there is one element present (due to the Level 1) in each of the sub-triangles, where every Sit_Number belonging to this level is sitting in the common edge of two of the sub-triangles.
In Level 3, there are two Elements present (due to the Level 1 & 2) in each of the sub-triangles, where every Sit_Number belonging to this level, is sitting in the common edge of two of them.

Moreover, in an on-line game, the player can choose an element and browse through the available uncompleted Game platforms which have his desired element untaken. The order of Game platforms shown is based on the number of available players in descending order from 7 to 1. In addition to the possibility of searching among the available Game platforms through the 8 elements, it may also be possible for the players to search for Game platforms with the most available players, regardless of the element(s) remaining, in order to start the Game as soon as possible.

A specific example of how to play the Game in accordance with this class will now be discussed. FIG. 12c illustrates how each player obtains his Sit-Hand in a round, by assuming that the system generated the Random_Order: {H-C-D-B-F-A-G-E} for that round and due to the odd and even teams.

In FIG. 12d, the Game platform is shown after generation of the Random-Order. The elements in white represent P.Elements while the elements in black represent the T.Elements. In other words, the 3 white elements are the element which was chosen by the player himself while the 3 black elements are the elements which were chosen by the 3 other players who are in the same team (odd or even) with that player. Basically the arrangement of T.Elements to the 3 Sit_Numbers which belong to a player is simply in alphabetical order based on the order of the 3 Levels which is placed during the Game. However, the player is allowed to assign every T.Element just once to one of his Sit_Numbers. Generally among the 3 Sit_Numbers belonging to a Sit_Order, the 3 T.Elements are replaceable, whereas the 3 P.Elements are non-replaceable.

Moreover, when the 10-second period is passed, the player is not allowed to change or replace the assigned element, regardless of type of that element.

FIG. 12e illustrates how the player who has obtained the Sit_Order 1 can choose his desired element at each level.

For further clarification, each Level is divided into 3 stages. The first stage of each Level is when each player's turn to choose an element for his Sit_Number during the 10-second period begins, and consequently the player's Sit_Number turns to red and lights up together with its P.Element and T.Element (if it wasn't taken in the previous Levels). In addition, any of the 2 other T.Elements (if they were not taken in the previous Levels) among the 2 other Sit_Numbers in the same Sit_Order lights up as well. The second stage of each Level shows the player's choice of desired element which consequently turns to red as well. Hereby, after choosing the desired element, the player can either click on the “Pass” button or wait until the rest of 10-second period is over which in both cases, thereby reaching the third stage. However as mentioned before, in the second stage by clicking directly on the “Pass” button without choosing any Element, the system assigns the P.Element, which belongs to that Sit_Number, as the chosen Element for that particular Sit_Number.

### Skill Class.2 (S2)

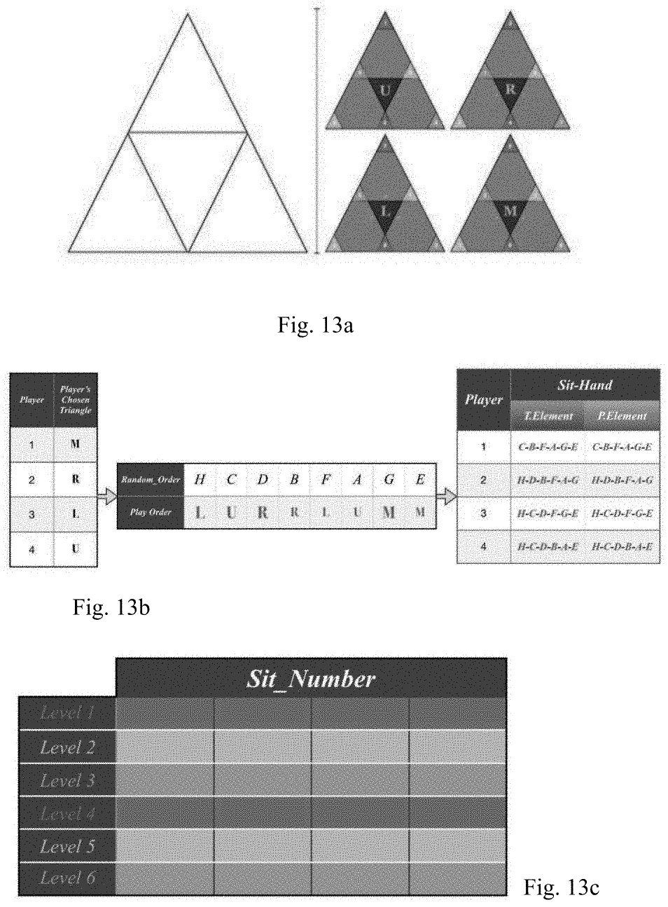

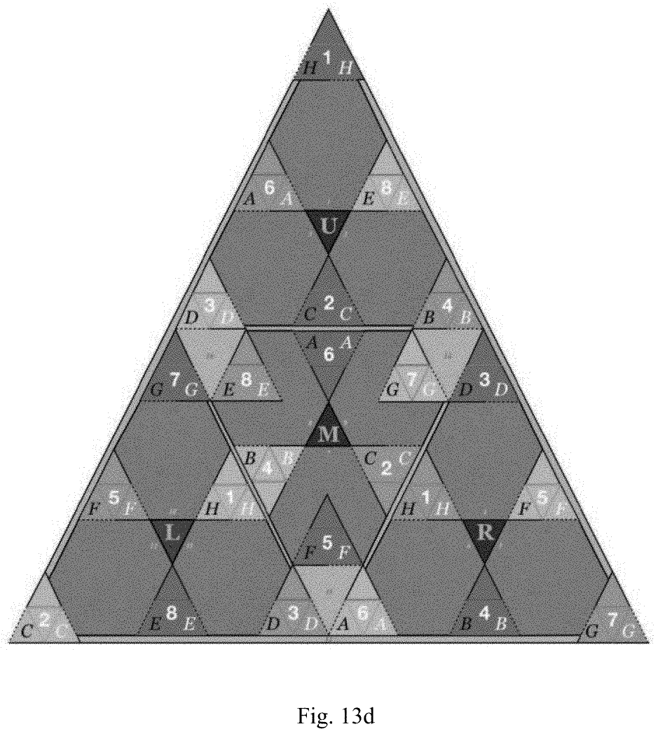

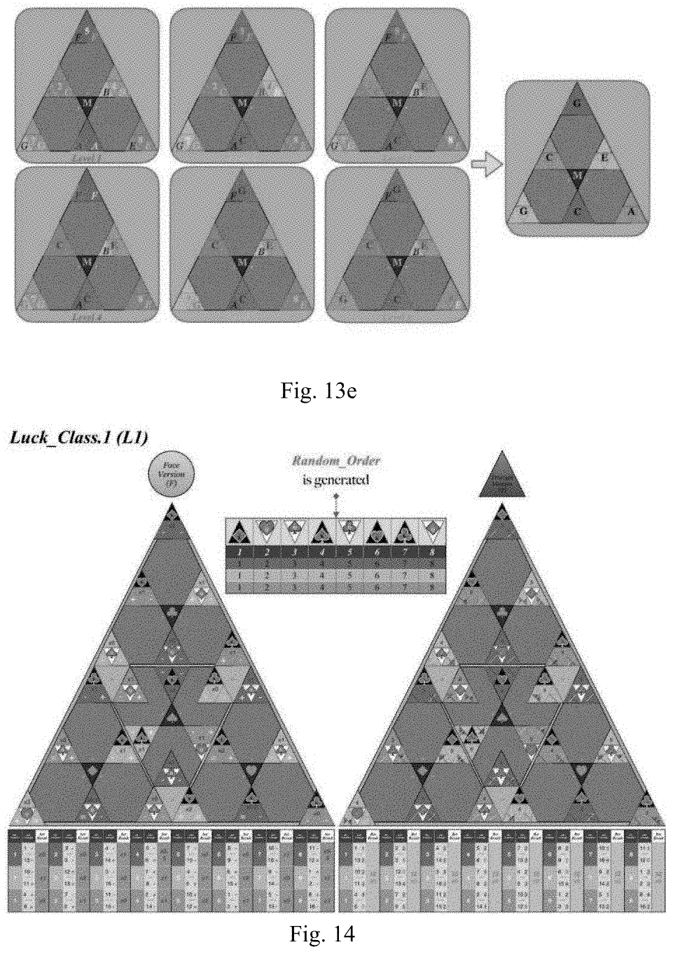

Similar to the Game in the class S1, the class S2 is for players who want to bet more based on their elements of skill than just luck. In this class 4 players compete against each other in the same Game platform. As mentioned before, the Game platform comprises 4 different second order triangles, where each of these second order triangles is connected with 2 of the other second order triangles through its 3 edges. Besides, each of these 4 second order triangles comprises 3 sub-triangles where every 2 sub-triangles are connected to each other via a common edge. Hence, each second order triangle comprises 6 Sit_Numbers throughout the 6 edges of its 3 sub-triangles, where 3 edges are the common edges between the 3 sub-triangles inside the second order triangle and each of the other 3 edges are an edge of the common sub-triangle between the 3 second order triangles. Further, each of the 4 second order triangles and the 16 sub-triangles comprises 3 edges in 3 available different colors. Furthermore, based on the special design of the Game platform, in this class each second order triangle is recognized by a predefined sign, as shown in FIG. 13a.

To this end, each of the 4 players picks one of the 4 Triangles (U-M-L-R). Therefore, by paying one initial bet, the player in fact places 6 bets on the 6 Sit_Numbers inside the picked triangle.

When all the 4 available players have chosen their triangles, the Game starts by generating a Random_Order.

The resulting Game platform resulting from this is shown in FIG. 13b.

In the Face Version: If a player chose to play in this Version of S2, his Initial-Bet is being split into 6 bets where at the end of a round, each bet gets its own result (Condition) based on the chosen Element's diagonal, as mentioned before.

In this class, every player has 12 choices of elements as his Sit-Hand. Hereby, based on the 6 available Sit_Numbers in every Triangle and due to the generated Random_Order, each player obtains 2 kinds of Elements:
T.Elements: First, the system applies the generated Random_Order into the Game platform. Therefore, every triangle obtains 6 Elements through its 6 Sit_Numbers. These 6 Elements are called T.Elements (T stands for Triangle in this class). Every player is allowed to assign each of the 6 T.Elements which belong to his chosen triangle just once to one of the 6 Sit_Numbers inside that triangle.
P.Element: In addition, every player obtains the 6 Elements which are assigned to his chosen triangle based on the generated Random_Order. These 6 Elements are called P.Elements (P stands for player). The player is allowed to assign each P.Element just to its generated Sit_Number.

When the 4 players got their P.Elements and T.Elements, the game starts from the first Triangle, due to the turn order based on the generated Random_Order. Hereby, the rule applied in this Skill_Class.2 is that the player shall assign the Elements for the 6 available Sit_Numbers inside his chosen Triangle somehow that at the end of the game, every 2 Sit_Numbers in the same color inside his Triangle must got assigned by any 2 Elements within the same sign. In other words, at the end of the game, in every Triangle the 2 Sit_Numbers in blue shall have 2 Elements with the same sign, the 2 Sit_Numbers in yellow shall have 2 Elements with the same sign and the 2 Sit_Numbers in green shall have 2 Elements with the same sign as well. However, if the player do not assign any Element during the 10-second period, the system will choose the P.Element, which was reserved for that Sit_Number based on the generated Random_Order, for that particular Sit_Number instead. Thereby, if the chosen or assigned 2 Elements for the 2 Sit_Numbers in the same color do not have the same sign, then the player has failed in whole his Triangle which consequently, all of the 6 Sit_Numbers throughout his chosen Triangle will get ×0 Condition at the end of the game. Hereby, despite the player is losing on all his bets (Sit_Numbers), his chosen Elements will still have their natural function inside any common sub-triangles (13-14-15-16) among the 4 Triangles.

In the Triangle Version: If a player chose to play in this Version of S2, his Initial-Bet is NOT being split where at the end of a round, all the 6 bets get just one result together. There is no rule in this Version of the game to pickup an Element! Hereby, between the players who could create at least 14 primitive square's triangles (U-R-M-L) among just the winning Elements inside their chosen Triangle:
The player with the highest number of triangles, wins JackPot (JP)
The second player with the highest number of triangles, wins double the bet (×2)
The third player with the highest number of triangles, gets back whole the Initial-Bet (×1)
The fourth player with the highest number of triangles, gets back half of the Initial-Bet (×0.5)
The player with the least number of triangles than 14, lose the whole Initial-Bet (×0)

It should be emphasized that for each player the number of triangles are being counted among any of the 6 Elements belonging to his chosen Triangle which got just Win result in any of their sub-triangles. By winning in a sub-triangle, it means that that Element could create a Shape including 1 or 2 triangles in combination with each of the other 2 Elements among that particular sub-triangle.

Moreover, for the same Initial-Bet, the Winning amount for a Bet in this Version (JP or ×2) is equal to the same Condition of just 1 of the 6 bets in the Face Version and on the other hand, the Equal (×1) or Losing (×0.5 & ×0) amount is equal to the same Condition of all the 6 bets in the Face Version! For instance, a 1.2€ Bet in FV that all its 6 bets got ×2 Condition earns: 1.2€ (the Initial-Bet)+[6×0.2€]=2.4€ while the same Bet in TV that got ×2 as its result earn: 1.2€ (the Initial-Bet)+[1×0.2€]=1.4€.

By assuming that more than one player have reached the same number of triangles (Min. 14), all of them wins the same final result.

In this class, the 4 players compete against each other in 6 different levels where each level contains 4 Sit_Numbers with the same color among the 4 Triangles, as represented in the table shown in FIG. 13c.

Since each triangle includes 6 Sit_Numbers, including three pairs of Sit_Numbers of the same color, there is no number represented as the Sit_Number in the table of FIG. 13c. Therefore each player is free to choose one of the 2 Sit_Numbers with the same color to assign an element to them in the first 3 Levels. Furthermore, the Game starts from the level 1 and ends at level 6. The turn order of playing among the 4 Triangles may be precisely based on the order of Triangles, or in fact the order of Elements signs toward a Random_Order.

When it is a player's turn, he has just 10 seconds to choose an element for his Sit_Number. Therefore, similar to class S1, the Game in this class takes not more than 2 minutes and 40 seconds as well from the moment that the 4 players with their chosen Triangles were present, and the system generated a Random_Order. However, a player may, after choosing the desired element for his Sit_Number, skip the remaining time of the 10-second period by pressing the “Pass” button.

In an alternative embodiment, the 4 triangles may be arranged inside the Game platform based on the generated Random_Order and on the fixed Platform_Order.

Generally, in this class, every player competes against each of the other 3 players through the common sub-triangles between every 3 Triangles as shown in the table below:

| Platform_Order | U-R-L | U-R-M | R-M-L | U-M-L |
|---|---|---|---|---|
| Sub-triangle | 200 (“13”) | 250 (“14”) | 260 (“15”) | 270 (“16”) |

Furthermore, the 6 Sit_Numbers in every Triangle can be organized in 2 categories:
The 3 Sit_Numbers that are sitting in the common edges of the 3 sub-triangles which forms that Triangle, for instance the Sit_Numbers 4, 5 and 1 in the Triangle R. As a matter of fact, the player does not compete with any other player on these 3 Sit_Numbers. Therefore, the player can literally decide upon the results of these 3 Sit_Numbers, of course based on his obtained T.Elements and P.Elements.
On the other hand, each of the 3 other Sit_Numbers is sitting in the common edge of a sub-triangle which belongs to that Triangle and another sub-triangle which connect that Triangle with 2 other Triangles, for instance the Sit_Numbers 3, 6 and 7 in the Triangle R. Hereby, the player competes directly with 2 other players on each of these 3 Sit_Numbers, and based on the turn order and other players choices in the previous levels, he can assign his desired element to that Sit_Number, of course restricted to his obtained T.Elements and P.Elements.

Moreover, when played as an on-line game, the player may choose a Triangle and browse through the available uncompleted Game platforms which have his desired Triangle untaken. The order in which the Game platforms are shown is preferably based on the number of available players in descending order from 3 to 1. In addition to the possibility of searching among the available Game platforms through the 4 Triangles, it may also be possible for the players who want to find the Game platforms with the most available players, to search for this regardless of the Triangle(s) remaining, to start the Game as soon as possible.

With reference to FIG. 13d, a further example of how this class may be plaid will be given. This figure illustrates how each player obtains his Sit-Hand in a round, by assuming that the system generated the Random_Order: {H-C-D-B-F-A-G-E} for that round.

In this Game platform, the elements in white represent the P.Elements while the Elements in black represent the T.Elements. Basically the arrangement of T.Elements toward the 6 Sit_Numbers in a Triangle which belongs to a player is simply according to the Random_Order, but during the Game, the player is able to replace them among his 6 Sit_Numbers. However, the player is allowed to assign every T.Element just once to one of his Sit_Numbers. Generally among the 6 Sit_Numbers belonging to a Triangle, the 6 T.Elements are replaceable, whereas the 6 P.Elements are non-replaceable.

Moreover, when the 10-second period is ended, the player is not allowed to change or replace the assigned element, regardless of type of that element.

FIG. 13e illustrate how the player who has chosen the Triangle M can choose his desired element at each level. The figure shows, for each level, the 10-second period of player 2's turn to choose an element:
At Level 1, Level 2 and Level 3, the 2 available Sit_Numbers in the same color light up together with their P.Elements and T.Elements (if they were not taken at previous levels). In addition, any of the 4 other T.Elements (if they were not taken in previous levels) among the 4 other Sit_Numbers in the same Triangle lights up as well. Hereby, the player has to choose primarily one of the 2 available Sit_Numbers and then his desired element to assign for that particular Sit_Number which consequently, by clicking on them, turn to red. Moreover, if the player chooses a Sit_Number and then without choosing any element clicks on the “Pass” button, the system assigns the chosen Sit_Number's P.Element for that particular Sit_Number. However if in any of these 3 Levels, the player does not choose any of the 2 available Sit_Numbers, either when the 10-second period is over or by clicking directly on the “Pass” button, the system will choose automatically the smallest Sit_Number and assign the P.Element which belongs to that Sit_Number, as the chosen element for that particular Sit_Number.
At Level 4, Level 5 and Level 6, the only available Sit_Number in each color turns to red and lights up together with its P.Element and T.Element (if they were not taken at previous levels). In addition, any of the 5 other T.Elements (if they were not taken at previous levels) among the 5 other Sit_Numbers in the same Triangle lights up as well. Hereby, the player simply clicks on his desired element during the 10-second period, which consequently turns to red as well. However, if the player clicks on the “Pass” button without choosing any element, the system assigns the P.Element, which belongs to that Sit_Number, as the chosen element for that particular Sit_Number.

### Game Pot and Game Revenue

If a player won the JP condition among 2 of his 6 bets in the Class L2, the winning JackPot amount for these 2 bets together is equal to the winning JackPot amount for just 1 bet with JP condition in the Class L1.

The amount of the initial bet may be fixed, and with a fixed currency, such as Swedish Crowns (SEK), US dollars, or the like. If several currencies are allowed, separate Games is preferably performed for each of these currencies. Further, the initial bets may have more than one amount. If two or more initial bet amounts are provided, the initial bet amount should preferably, at least in Skill_Class 1 and 2, be the same for each player at any particular round of the game. Thus, players using one initial bet amount will play against players using the same initial bet amount, whereas other players using another initial bet size will play against each other separately.

For every currency, a round of the game in any class has its own Pot called Round-Pot, where all the initial bets belonging to the players who are participating in that round, regardless of the two different amounts, are gathered. Hereby, based on the Game class, the Round-Pot will be:
In the Class L1: The sum of the initial bets of all the players who are participating in the same round.
In the Class L2: The initial bet(s) of the only participated player, since this class is a solo game.
In the Class S1: The sum of initial bets of the 8 players who are competing against each other in the same Game platform.
In the Class S2: The sum of initial bets of the 4 players who are competing with each other in the same Game platform.

The money won by the players may be paid out immediately at the end of a tournament. For convenience, and to enable for the players to attend in more rounds of any classes during a Tournament, it is preferred that regardless of the class, any bet with one of the conditions: JP, ×2 and ×1 gets back whole of its bet-cost immediately, and any bet with the condition: ×0.5 immediately gets back half of its bet-cost. Moreover, this winning money is paid back from the Round-Pot of the round where that bet was made.

In a tournament, each currency may have its own pot, referred to as Tournament-Pot, where the remaining amount of the Round-Pots (after paying back the bet-costs of the bets with conditions JP, ×2, ×1 and ×0.5) are transferred to that particular Tournament-Pot. In other words, every Tournament-Pot is in fact the sum of the bet-costs of the bets with ×0 condition and half of the bet-costs of the bets with ×0.5 condition.

Furthermore, in a preferred embodiment, the following will be deducted from each Tournament-Pot:
8% will be deducted as the basic amount of a pot for the same currency in the next-hour tournament.
2% will be withdrawn as the Game commission, referred to as Tournament_Commission.

The remaining amount of each Tournament-Pot, after the deduction, is referred to as the Bonus-Pot. Thus, by using the deductions in the example above, the Bonus-Pot will be:

Bonus-Pot=Tournament-Pot×(100%−8%−2%)=Tournament-Pot×90%

In addition to the bet-cost that the bets with conditions JP and ×2 are getting back immediately, they are also winning extra amounts as well. Therefore, each of these bets have the right to a portion of the Bonus_Pot, which may be referred to as Pot-Dividend.

For the bets winning by the ×2 condition, the amount of the Pot-Dividend may be equal to an essential currency amount (ECA) of the respective currency multiplied with the winning absolute value (WAV) of the respective game, as well as the initial bet.

For the bets winning by the JP condition, the system shows and registers the respective WAV behind a JackPot sign. For instance, if a bet on $6 with Face Version L1 won by JP condition, the player may see the result as 10×JP. The basic amount of JP's Pot-Dividend may be calculated in the following way:

JP's Pot-Dividend=[Bonus-Pot−Bonus Pot-Dividend paid to bets with ×2condition]/[number of bets with JP condition]

Thus, first the Pot-Dividends paid to the bets with the ×2 conditions is taken away from the Bonus-Pot, and the rest is then split between all the bets with JP condition.

The JP's Pot-Dividend will in most cases be a decimal number. In one embodiment, only the whole number part of the JP's Pot-Dividend is paid out to the players, whereas the decimal part is kept as a further Game commission, referred to as JackPot_Commission. Thus, in such an embodiment, the JP's Pot-Dividend comprises a whole number part—the JackPot_Bonus—and a decimal part—the JackPot_Commission.

Therefore, the amount of game revenue from a Tournament-Pot in a tournament is equal to 2% of that Tournament-Pot plus the sum of decimal portions of all the JP's Pot-Dividend. Since the bets with conditions JP, ×2, ×1 immediately get back their bet-costs and the bets with ×0.5 condition get back half of their bet-costs. After a tournament, the Game_Revenue will be deducted from the bets with JP condition. In other words, the bets with conditions ×2, ×1, ×0.5 and ×0 do not pay any commissions whatsoever.

Furthermore, by assuming that there is no bet with JP Condition in a Bonus-Pot, after withdrawing the 10% and paying off the ×2_Bonuses, the rest of that Bonus-Pot will be transferred, as a starting amount, to the game pot for the same currency in the next-hour tournament together with the 8%.

### ALTERNATIVE EMBODIMENTS

Many alternatives to the above-discussed realization are feasible, as would be appreciated by the skilled reader. Some such alternatives will be discussed briefly in the following.

Firstly, instead of having elements forming squared boxes as a differentiating, characteristic feature when combined with other elements, other geometrical shapes are also feasible. For example, the separating lines within the box may be drawn as diagonal lines instead of as vertical and horizontal lines, as discussed in the foregoing.

Further, the order of the four second order triangles within the game platform may be a fixed order. However, in all of the game classes, the second order triangles may be assigned to a specific location in the game platform upon initiation of each game, e.g. by using the method discussed in relation to Skill_Class.2 (S2), i.e. by being assigned a specific location based on the Random_Order that is generated for the game.

Further, the initial bet may be split into 3 bets, assigned to the 3 different colors of the Sit_Number. This may be referred to as the Face-version of the game. However, in an alternative, the initial bet is not split, and the 3 Sit_Number of different colors just get one result. In such a game, and using the triangular elements discussed above, any player that can build at least 14 small triangles, in both winning and losing sub-triangles, among his Sit_Order, can win any of the conditions JP (first place), ×2 (second place), ×1 (third place) and ×0.5 (fourth place). This way of playing the game may be referred to as Triangle-version.

When e.g. playing in a Luck_Class.1 (L1), the game may follow the steps:
Generate a Random_Order
Apply the Random_Order on the platform, so that elements are placed in all the playing areas.
Presenting the result for every sub-triangle on the platform.
   In FIG. 14, such presentations of the results are shown, both for the Face version (to the left) and the Triangle version (to the right).

Similarly, for Luck_Class.2 (L2), the initial bet will, in the Face version, be split into 6 bets among the 6 Sit_Numbers within the second order Triangle that is chosen. However, in the Triangle version, the initial bet is not split, and the 6 Sit_Numbers get just 1 result together. Again, any player that can build at least 14 small closed triangles, now only in winning sub-triangles, through his Triangle can win conditions JP (first place), ×2 (second place), ×1 (third place) or ×0.5 (fourth place).

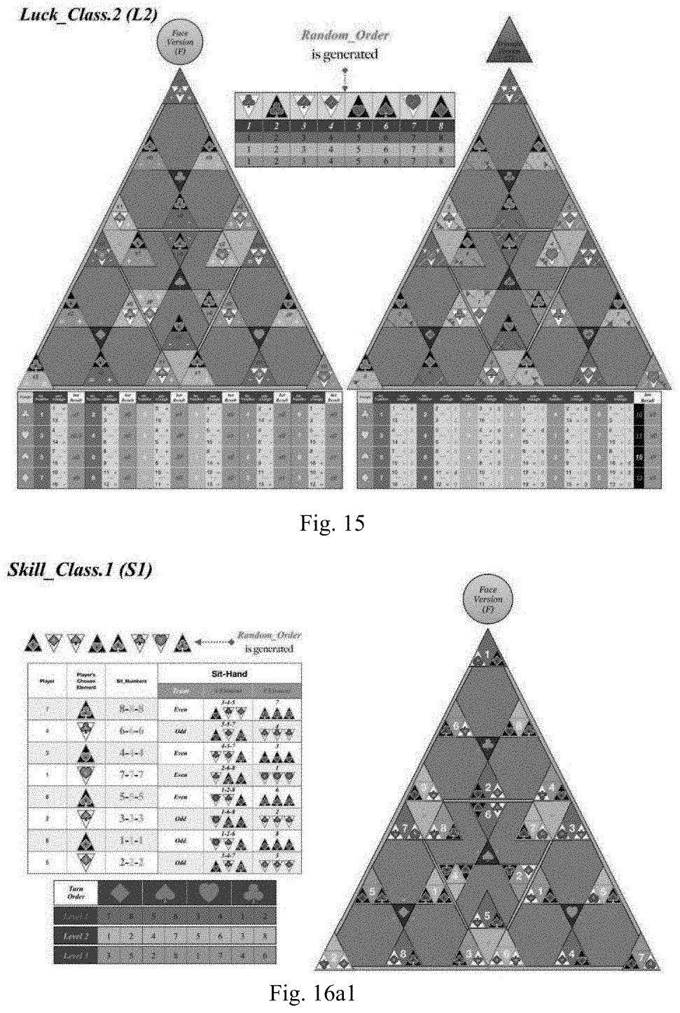

When playing L2, the game may follow these steps:
Generate a Random_Order.
Apply the Random_Order on the platform, so that elements are placed in all the playing areas.
Presenting the result for every sub-triangle on the platform. Again, the result may be presented in the same way as shown in FIG. 14 for the Face version and the Triangle version, respectively. Such presentations are shown in FIG. 15, illustrating the result of a face version to the left and a triangle version to the right.

In Skill_Class.1 (S1), the initial bet will, in the Triangle version, not be spilt into the 3 Sit_Numbers. Instead, the 3 Sit_Numbers get just one result together. Again, any player that can build at least 14 small closed triangles, now in both winning and losing triangles, through his Sit-Order can win conditions JP (first place), ×2 (second place), ×1 (third place) or ×0.5 (fourth place).

In the Face version of S1, and as discussed previously, each player choses one element, which are divided into three (P.Elements) and three inherited elements from the other players in the same team (T.Elements). Each player is able to choose any of the 3 inherited T.Elements just once for any of his 3 Sit_Numbers. In addition, the player can assign his own chosen element, the P.Elements, 3 times to his 3 Sit_Numbers. Each round is in 3 levels, and the game starts from level 1 (e.g. blue), to level 3 (e.g. green); from the first Triangle in accordance with the turn order based on the generated Random_order; and from the smallest Sit_Number.

When the game starts, a Random_Order may be generated, and used to assign the second order triangles to the platform.

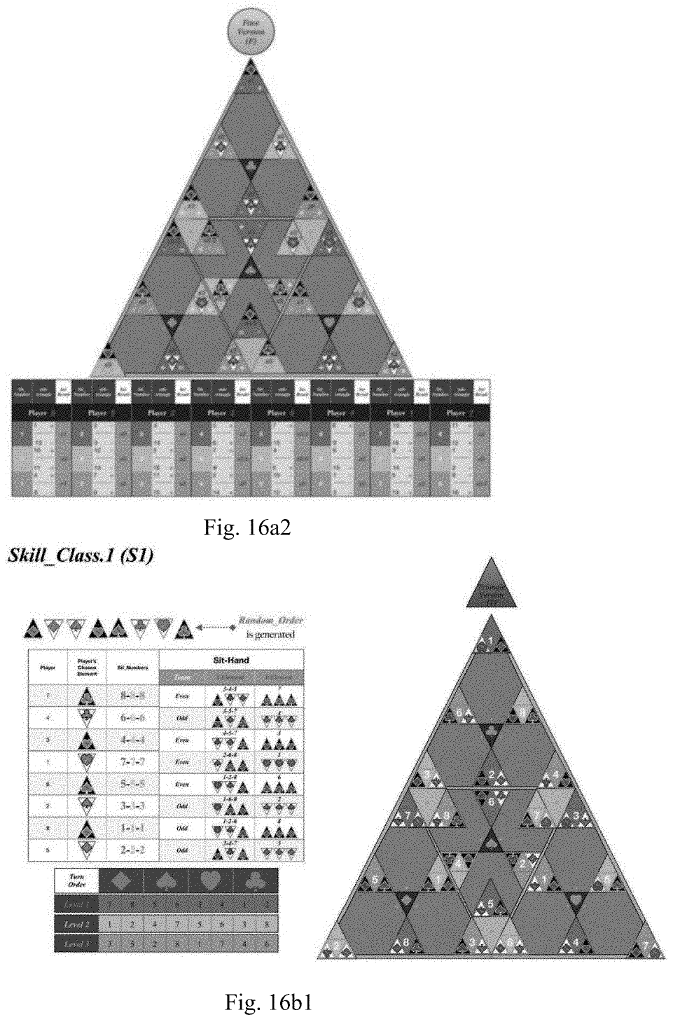

In FIG. 16a1, a2, b1 and b2 an example is given on how S1 may be played. FIG. 16a1 and ba show the Sit_Hands at the moment after the Random_Order has been generated and the players received their Sit_Hands, but before the first player starts to actually play. FIGS. 16a2 and b2 show a presumed final standing, after having completed the third level FIG. 16a1 and a2 illustrate a face version of the game, whereas FIG. 16b1 and b2 illustrate a triangle version of the game.

In the Triangle version of Skill_Class.2 (S2), the initial bet is also not split, and the 6 Sit_Numbers get just 1 result together. Any player that can build at least 14 small closed triangle, here in just winning sub-triangles, through his Triangle can win conditions JP (first place), ×2 (second place), ×1 (third place) or ×0.5 (fourth place).

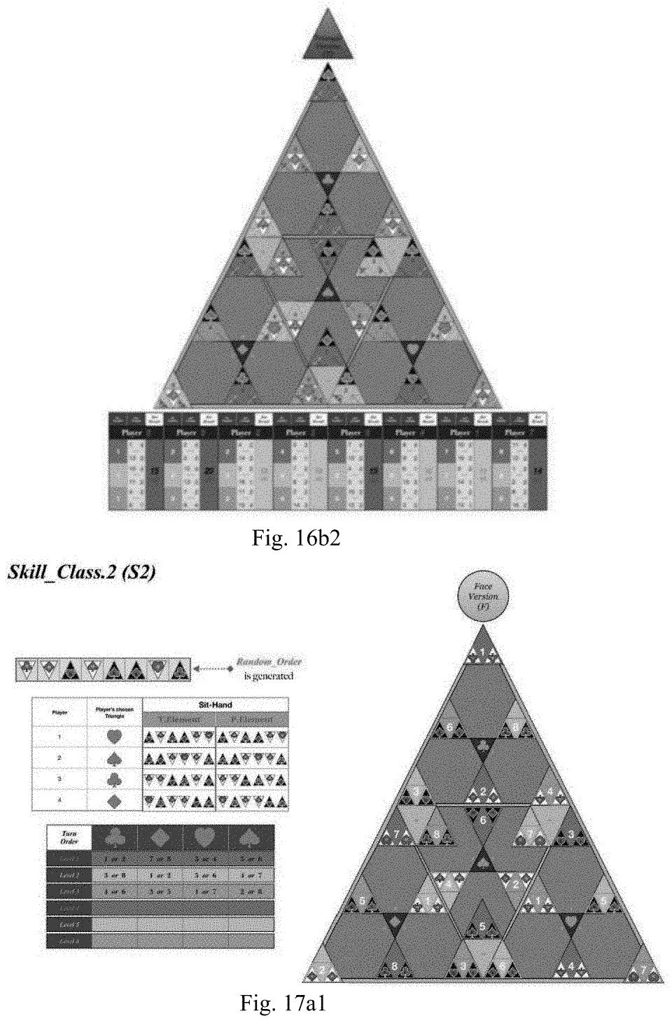

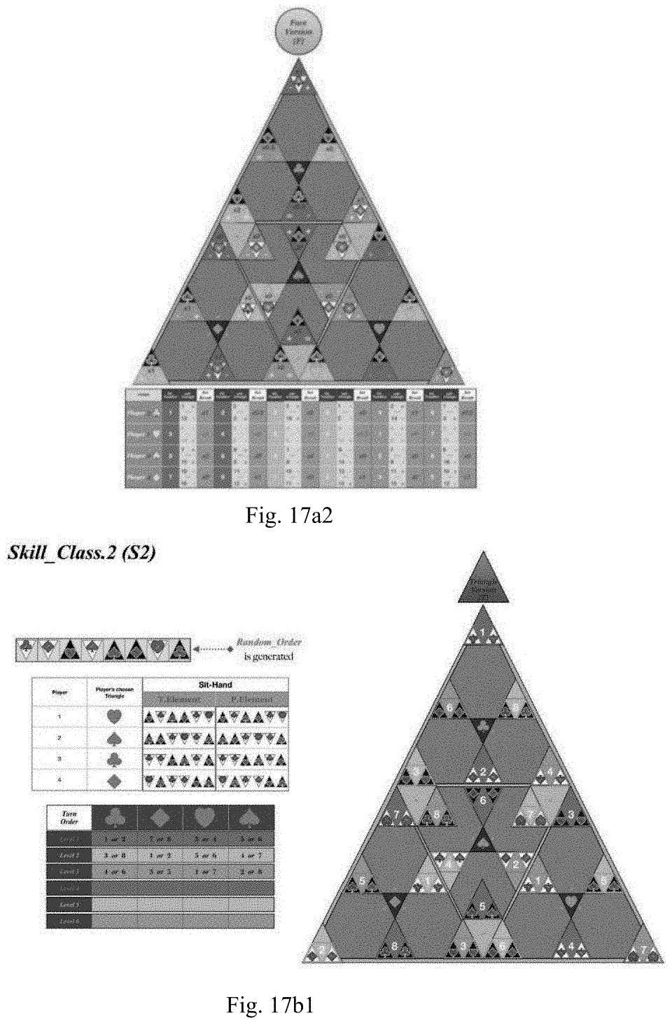

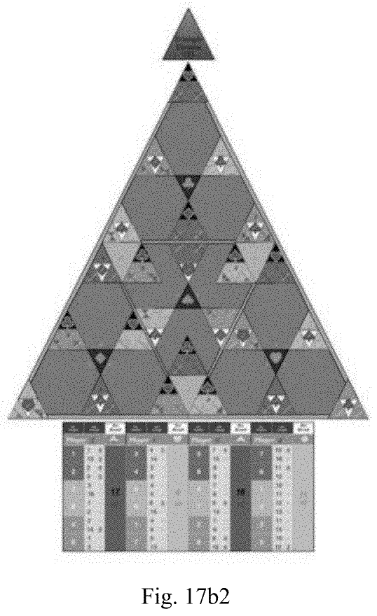

FIGS. 17a1, 17a2, 17b1 and 17b2 illustrate an example of S2 played in the face version, FIGS. 17a1 and 17a2, and the triangle version, FIGS. 17b1 and 17b2. FIGS. 17a1 and 17b1 show the moment after the Random_order has been generated and the players have received their Sit_Hand, and before the first player start actually to play, whereas FIGS. 17a2 and 17b2 show the final standing, after having completed the sixth level.

Specific embodiments of the invention have now been described. However, several other alternatives are also possible, as would be apparent for someone skilled in the art. For example, the game and platform may be realized in software, and e.g. operated as an on-line game, but may also fully or partly be realized in hardware. Further, the elements may be realized in other ways, providing the same or other types of distinguishing features when combined. Further, more or fewer elements, play areas, sub-triangles and the like may be provided.

Such and other obvious modifications must be considered to be within the scope of the present invention, as it is defined by the appended claims. It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting to the claim. The word “comprising” does not exclude the presence of other elements or steps than those listed in the claim. The word “a” or “an” preceding an element does not exclude the presence of a plurality of such elements. Further, a single unit may perform the functions of several means recited in the claims.

What is claimed is:

1. A game platform for a gambling game, comprising:
a main triangle with three edges;
a plurality of equally sized second order triangles arranged non-overlapping within the bounds of the main triangle;
a plurality of sub-triangles arranged within each second order triangle, the sub-triangles within each second order triangle partly overlapping each other, so that edges of pairs of sub-triangles are coinciding with each other;
additional sub-triangles formed in border areas where the edges of the second-order triangles meet;
an additional sub-triangle formed by the main triangle; and
play areas arranged at each edge area of each sub-triangle, wherein each play area is arranged at, or in the vicinity of, an edge in two different sub-triangles.

2. The game platform of claim 1, wherein four second order triangles are provided within the main triangle, three of which are arranged at each edge of the main triangle, and one being arranged in the center.

3. The game platform of claim 2, wherein the four second order triangles are essentially filling the area of the main triangle, and wherein the three triangles at the edges are directed in the same way as the main triangle, whereas the fourth triangle arranged in the center is oppositely directed.

4. The game platform of claim 1, wherein three sub-triangles are provided in each of the second order triangles.

5. The game platform of claim 1, wherein a totality of 16 sub-triangles and 24 playing areas are provided in the platform.

6. The game platform of claim 1, wherein each playing area is semi-randomly assigned a sequential number, referred to as “Sit_Number”.

7. The game platform of claim 1, wherein each second order triangle comprises six play areas.

8. The game platform of claim 7, wherein the play areas in each second order triangle comprises play areas in three different colors, forming three pairs of equally colored play areas, wherein one of the play areas of each such pair is arranged at an edge of the second order triangle, and the other play area of the pair is arranged oppositely to this edge, at the middle of the opposite vertex.

9. The game platform of claim 7, wherein each sub-triangle comprises three play areas of different colors, whereby play areas of all the three colors are present in each sub-triangle.

10. The game platform of claim 7, wherein the play areas are sequentially numbered, wherein the number series is repeated for each color of the play areas.

11. A method for playing a gambling game, comprising:
providing a game platform in accordance with claim 1;
providing a set of distinct elements, wherein each combination of any two of these element result in a characteristic feature being either present or non-present in such a combination:
assigning the elements to the play areas of the game platform;
determine which possible combinations of elements within at least some of the sub-triangles that contain the characteristic feature and which do not;
determine elements that wins, loses or are equal in each sub-triangle based on the characteristic features of these combinations.

12. The method of claim 11, wherein the elements comprises distinct geometrical shapes, which, when combined, either form distinctive closed structures or not.

13. The method of claim 12, wherein the distinctive closed structures are squares or triangles.

14. The method of claim 12, wherein eight different, distinct elements are provided.

15. The method of claim 12, wherein more than 50% of all possible combinations of the elements result in the characteristic feature being present, and wherein combination with the characteristic feature being present wins over combinations where the characteristic feature is not present.

16. The method of claim 15, wherein 55-60% of all possible combinations of the elements result in the characteristic feature being present.
